(19) United States
(12) Patent Application Publication
(10) Pub. No.: US 2023/0224512 A1
(43) Pub. Date: Jul. 13, 2023

(54) SYSTEM AND METHOD OF SERVER-SIDE DYNAMIC ADAPTATION FOR SPLIT RENDERING

(71) Applicant: MEDIATEK Singapore Pte. Ltd., Singapore (SG)

(72) Inventors: Xin Wang, San Jose, CA (US); Lulin Chen, San Jose, CA (US)

(73) Assignee: MEDIATEK Singapore Pte. Ltd., Singapore (SG)

(21) Appl. No.: 18/092,845

(22) Filed: Jan. 3, 2023

Related U.S. Application Data
(60) Provisional application No. 63/298,655, filed on Jan. 12, 2022.

(51) Int. Cl. H04N 21/234; H04N 21/81; H04N 21/44; H04N 21/258; H04N 21/239

(52) U.S. Cl. CPC H04N 21/23412; H04N 21/816; H04N 21/8146; H04N 21/44; H04N 21/258; H04N 21/2393

(57) ABSTRACT

The techniques described herein relate to methods, apparatus, and computer readable media configured to provide video data for immersive media implemented by a server in communication with a client device. A request to access a stream of media data associated with immersive content at a point in time the client is first accessing the stream of media data for the immersive content is received from the client device. In response to the request from the client, the server transmits a response indication whether it has rendered at least part of the stream of media data. The server may also determine, based on the request from the client, whether to render at least part of the stream of media data for delivery to the client device.

### RELATED APPLICATIONS

This application claims priority under 35 U.S.C. § 119(e) to U.S. Provisional Application No. 63/298,655, filed Jan. 12, 2022, and entitled “SYSTEM AND METHOD OF SERVER-SIDE DYNAMIC ADAPTATION FOR SPLIT RENDERING,” which is hereby incorporated by reference herein in its entirety.

### TECHNICAL FIELD

The techniques described herein relate generally to server-side dynamic adaptation for media processing and streaming, including for split rendering where portions of content may be rendered by the server and the client.

### BACKGROUND OF INVENTION

Various types of 3D content and multi-directional content exist. For example, omnidirectional video is a type of video that is captured using a set of cameras, as opposed to just a single camera as done with traditional unidirectional video. For example, cameras can be placed around a particular center point, so that each camera captures a portion of video on a spherical coverage of the scene to capture 360-degree video. Video from multiple cameras can be stitched, possibly rotated, and projected to generate a projected two-dimensional picture representing the spherical content. For example, an equal rectangular projection can be used to put the spherical map into a two-dimensional image. This can be then further processed, for example, using two-dimensional encoding and compression techniques. Ultimately, the encoded and compressed content is stored and delivered using a desired delivery mechanism (e.g., thumb drive, digital video disk (DVD), file download, digital broadcast, and/or online streaming). Such video can be used for virtual reality (VR) and/or 3D video.

At the client side, when the client processes the content, a video decoder decodes the encoded and compressed video and performs a reverse-projection to put the content back onto the sphere. A user can then view the rendered content, such as using a head-mounted viewing device. The content is often rendered according to a user's viewport, which represents an angle at which the user is looking at the content. The viewport may also include a component that represents the viewing area, which can describe how large, and in what shape, the area is that is being viewed by the viewer at the particular angle.

When the video processing is not done in a viewport-dependent manner, such that the video encoder and/or decoder do not know what the user will actually view, then the whole encoding, delivery and decoding process will process the entire spherical content. This can allow, for example, the user to view the content at any particular viewport and/or area, since all of the spherical content is encoded, delivered and decoded. However, processing all of the spherical content can be compute intensive and can consume significant bandwidth.

Online streaming techniques, such as dynamic adaptive streaming over HTTP (DASH), HTTP Live Streaming (HLS), etc., can provide adaptive bitrate media streaming techniques (including multi-directional content and/or other media content). DASH can, for example, allow a client to request one of multiple versions of content that are available in a manner such that the requested content is chosen by the client to meet the client's current needs and/or processing capabilities. However, such streaming techniques require the client to perform such adaptation, which can place a heavy burden on client devices and/or may not be achievable by low-cost devices.

### SUMMARY OF INVENTION

In accordance with the disclosed subject matter, apparatus, systems, and methods are provided, such as for implementing dynamic adaptation for media processing and streaming, including for split rendering where portions of content may be rendered by the server and the client.

Some embodiments relate to a method for providing video data for immersive media implemented by a server in communication with a client device, the method includes: receiving, from the client device, a request to access a stream of media data associated with immersive content, wherein the request includes a rendering request for the server to render at least part of the stream of media data prior to transmission of the at least part of the stream of media data to the client; determining, based on the rendering request, whether to render the at least part of the stream of media data for delivery to the client device; and transmitting, in response to the request to access the stream of media data, a response to the client indicating the determination.

In some examples, the at least part of the stream of media data includes a plurality of layers of media data. In some examples, the plurality of layers of media data include a foreground layer, a background layer, or both. In some examples, the rendering request includes a request to render the foreground layer, the background layer, or both.

In some examples, the rendering request includes a request to not render the at least part of the stream of media data. In some examples, the rendering request includes a request to render an additional part of the stream of media data. In some examples, the rendering request includes a request to compose rendered content.

In some examples, determining, based on the rendering request, whether to render the at least part of the stream of media data includes: determining to render the at least part of the stream of media data; rendering the at least part of the stream of media data to produce a rendered representation of the at least part of the stream of media data; and transmitting the rendered representation of the at least part of the stream of media data to the client.

In some examples, the determining, based on the rendering request, whether to render the at least part of the stream of media data includes: determining not to render the at least part of the stream of media data.

In some examples, the method further includes: receiving, from the client device, a first set of one or more parameters associated with a viewport of the client device; rendering the at least part of the stream of media data in accordance with the first set of one or more parameters to produce a rendered representation of the at least part of the stream of media data; and transmitting the rendered representation of the at least part of the stream of media data to the client. In some examples, the first set of one or more parameters includes one or more of an azimuth, an elevation, an azimuth range, an elevation range, a position, and a rotation. In some examples, the position includes three dimensional rectangular coordinates. In some examples, the rotation includes three rotational components in a three-dimensional rectangular coordinate system.

In some examples, the method further includes: receiving, from the client device, a second set of one or more parameters associated with a spatial, planar object wherein said rendering the at least part of the stream of media data is done in accordance with both the first set of one or more parameters and the second set of one or more parameters. In some examples, the second set of one or more parameters includes one or more of a position of a portion of the object, a width of the object, and a height of the object. In some examples, the position of the portion of the object includes a horizontal position of a top left corner of the object and a vertical position of the top left corner of the object. In some examples, the width of the object and/or the height of the object have arbitrary units.

Some embodiments relate to a method for obtaining video data for immersive media implemented by a client device in communication with a server, the method including: transmitting, to the server a request to access a stream of media data associated with immersive content, wherein the request includes a rendering request for the server to render at least part of the stream of media data; receiving a response indicating whether the server rendered the at least part of the stream of media data; and receiving, if the response indicates that the server rendered the at least part of the stream of media data, a rendered representation of the at least part of the stream of media data.

In some examples, the at least part of the stream of media data includes a plurality of layers of media data. In some examples, the plurality of layers of media data include a foreground layer or a background layer or both. In some examples, the rendering request includes a request to render the foreground layer, the background layer, or both.

In some examples, the rendering request includes a request to not render the at least part of the stream of media data. In some examples, the rendering request includes a request to render all of the stream of media data. In some examples, the rendering request includes a request to compose rendered content.

In some examples, the method includes, if the response indicates that the server did not render the at least part of the stream of media data, rendering a representation of the at least part of the stream of media data.

In some examples, the method further includes: transmitting, to the server, a first set of one or more parameters associated with a viewport of the client device; and if the response indicates that the server rendered the at least part of the stream of media data, receiving, from the server, a rendered representation of the at least part of the stream of media data in accordance with the first set of one or more parameters. In some examples, the first set of one or more parameters includes one or more of an azimuth, an elevation, an azimuth range, an elevation range, a position, and a rotation. In some examples, the position includes three dimensional rectangular coordinates. In some examples, the rotation includes three rotational components in a three-dimensional rectangular coordinate system.

In some examples, the method further includes: transmitting, to the server, a second set of one or more parameters associated with a spatial, planar object; and if the response indicates that the server rendered the at least part of the stream of media data, receiving, from the server, a rendered representation of the at least part of the stream of media data in accordance with the first set of one or more parameters and the second set of one or more parameters. In some examples, the second set of one or more parameters includes one or more of a position of a portion of the object, a width of the object, and a height of the object. In some examples, the position of a portion of the object includes a horizontal position of a top left corner of the object and a vertical position of the top left corner of the object. In some examples, the width of the object and/or the height of the object have arbitrary units.

Some embodiments relate to a system configured to provide video data for immersive media including a processor in communication with memory, the processor being configured to execute instructions stored in the memory that cause the processor to perform: receiving a request to access a stream of media data associated with immersive content, wherein the request includes a rendering request for the server to render at least part of the stream of media data prior to transmission of the at least part of the stream of media data; determining, based on the rendering request, whether to render the at least part of the stream of media data; and transmitting, in response to the request to access the stream of media data, a response indicating the determination.

In some examples, the determining, based on the rendering request, whether to render the at least part of the stream of media data includes: determining to render the at least part of the stream of media data; rendering the at least part of the stream of media data to produce a rendered representation of the at least part of the stream of media data; and transmitting the rendered representation of the at least part of the stream of media data.

In some examples, the determining, based on the rendering request, whether to render the at least part of the stream of media data includes: determining not to render the at least part of the stream of media data.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto. It is to be understood that the phraseology and terminology employed herein are for the purpose of description and should not be regarded as limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 shows an exemplary video coding configuration, according to some embodiments.

FIG. 2 shows a viewport dependent content flow process for virtual reality (VR) content, according to some examples.

FIG. 3 shows an exemplary track hierarchical structure, according to some embodiments.

FIG. 4 shows an example of a track derivation operation, according to some examples.

FIG. 5 shows an exemplary configuration of an adaptive streaming system, according to some embodiments.

FIG. 6 shows an exemplary media presentation description, according to some examples.

FIG. 7 shows an exemplary configuration of a client-side adaptive streaming system, according to some embodiments.

FIG. 8 shows an example of end-to-end streaming media processing, according to some embodiments.

FIG. 9 shows an exemplary configuration of a server-side adaptive streaming system, according to some embodiments.

FIG. 10 shows an example of end-to-end streaming media processing using server-side adaptive streaming, according to some embodiments.

FIG. 11 shows an exemplary configuration of a mixed-side adaptive streaming system, according to some embodiments.

FIG. 12 shows an exemplary list of parameters for track selection or switching, according to some embodiments.

FIG. 13 shows exemplary viewport/viewpoint related data structure attributes, according to some embodiments.

FIG. 14 shows an exemplary list of viewport, viewpoint, and spatial-object related data structure attributes for spherical, cuboid, and planar regions, according to some embodiments.

FIG. 15 shows an exemplary list of temporal adaptation related attributes that may be used by a client device, such as to indicate to the server if a media request is for tuning into a live event or joining fast into a stream, according to some embodiments.

FIG. 16 shows multiple representations in an adaptation set for client-side adaptive streaming, according to some embodiments.

FIG. 17 shows a single representation in an adaptation set for server-side adaptive streaming, according to some embodiments.

FIG. 18 shows the viewport dependent content flow process of FIG. 2 for VR content modified for a server-side streaming adaptation, according to some examples.

FIG. 19 shows an exemplary computerized method for a server providing video data for immersive media in communication with a client device, according to some embodiments.

FIG. 20 shows an additional exemplary computerized method for a server providing video data for immersive media in communication with a client device, according to some embodiments.

FIG. 21 shows an exemplary computerized method for a client device obtaining video data for immersive media in communication with a server, according to some embodiments.

FIG. 22 illustrates the movement of some processing from the client with Client Side Dynamic Adaptation (CSDA) to the server with Server Side Dynamic Adaptation (SSDA), according to some embodiments.

FIG. 23 shows a mixed side dynamic adaptation (XSDA), wherein a portion of the dynamic adaptation is done at the client and a portion is done at the server, according to some embodiments.

FIG. 24 shows how various types of messages can be exchanged among the DASH clients, DANEs, and a metric server, according to some embodiments.

FIG. 25 lists a collection of rendering adaptation related parameters for use cases wherein streaming clients and servers split rendering of foreground and background content, possibly within a user's viewport, according to some embodiments.

FIG. 26 is a listing of exemplary valid mode values for an alpha blending mode, according to some embodiments.

FIG. 27 shows an example of a projection composition layer and the resulting composited distorted image for layer composition using a compositor, according to some embodiments.

FIG. 28 depicts an exemplary tile (e.g., sub-picture) based viewport dependent media processing for omnidirectional media content.

FIG. 29 illustrates an exemplary client architecture for viewport dependent immersive media processing.

### DETAILED DESCRIPTION OF INVENTION

Conventional adaptive media streaming techniques rely on the client device to perform adaptation, which the client typically performs based on adaptation parameters that are determined by and/or available to the client. For example, the client can receive a description of the available media (e.g., including different available bitrates), determine its processing capabilities and/or network bandwidth, and use the determined information to select a best available bitrate from the available bitrates that meets the client's current processing capabilities. The client can update the associated adaptation parameters over time, and adjust the requested bitrate accordingly to dynamically adjust the content for changing client conditions.

Deficiencies can exist with conventional client-side streaming adaptation approaches. In particular, such paradigms place the burden of content adaptation on the client, such that the client is responsible for obtaining its relevant processing parameters and processing the available content to select among the available representations to find the best representation for the client's parameters. The adaptation process is iterative, such that the client has to repeatedly perform the adaptation process over time.

In particular, client-side driven streaming adaptation, in which the client requests content based on the user's viewport, often requires the client to make multiple requests for tiles and/or portions of pictures within a user's viewport at any given time (e.g., which may only be a small portion of the available content). Accordingly, the client subsequently receives and processes the various tiles or portions of the pictures (e.g., including composition and rendering), which the client has to combine for display. This is generally referred to as client-side dynamic adaptation (CSDA). Because CSDA approaches require the client to download multiple data for multiple tiles, the client is often required to stitch the tiles on-the-fly at the client device. This can therefore require seamless stitching of tile segments on the client side. CSDA approaches also require consistent quality management for retrieved and stitched tile segments, e.g., to avoid stitching of tiles of different qualities. Some CSDA approaches attempt to predict a user's movement (and thus the viewport), which typically requires buffer management to buffer tiles related to the users predicted movement, and possibly downloading tiles that may not ultimately be used (e.g., if the user's movement is not as predicted).

Accordingly, a heavy computational and processing burden is placed on the client, and it requires the client device to have sufficient minimum-processing capabilities. Such client-side burdens can be further compounded based on certain types of content. For example, some content (e.g., immersive media content) requires the client to perform various compute-intensive processing steps in order to decode and render the content to the user.

In server-side dynamic adaptation (SSDA), the computational and processing burden can be shifted from the client to the server. The SSDA-based approach is still client driven because it is based on client requests. The SSDA-based approach is server assisted, meaning that the server fulfills client requests according to its best capabilities (e.g., such that the server may perform processing as requested by the client if possible, or the server may refuse such a request if it is not possible based on the current processing).

To address these and other problems with conventional client-side driven streaming adaptation approaches and SSDA, the techniques described herein provide for split rendering where a media and/or network server may perform some aspects of streaming adaptation while a client device may perform other aspects of streaming adaptation. Thus, the rendering load can be split between the client side and the server side. Split rendering can be dynamic, based on a client's static and dynamic capabilities. For example, a client's hardware/software capabilities are static and a client's network bandwidth, and resource availability (e.g., buffer level and power consumption) may be dynamic. Such techniques can be beneficial when the client device has limitations on processing or rendering of the content. Further, such techniques can be beneficial for complex content, such as immersive media content that involves point cloud objects, video objects, many sources, etc. Such content can place a high demand on device capability and resources. As a result, some devices may, at some point, need the server side (e.g., server and/or other processing entity(ies)) to help to ease the burden on the client device. The techniques differ from pre-determined split rendering, where rendering may be pre-established between the client and server sides. In contrast, the techniques described herein are client driven, so that the client can determine whether to request split rendering (or not). Further, the techniques are server-assisted, such that the server can determine whether to fulfil the client's request according to its best capabilities. Additionally, the client can vary its requests over time, such as based on changing resources, battery power, buffer space, and/or the like.

In some embodiments, the client device can provide rendering information to the server. For example, in some embodiments the client device can provide viewport information to the server for immersive media scenarios. For example, the viewport information may include viewport direction, size, height, and/or width. The server can use the viewport information to construct the viewport for the client at the server-side, instead of requiring the client device to perform the stitching and construction of the viewport. The server may then subsequently determine the regions and/or tiles corresponding to the viewport and perform stitching of the regions and/or tiles Accordingly, spatial media processing tasks can be moved to the server-side of adaptive streaming implementations. According to some embodiments, in response to detecting that the viewport has changed, the client device may transmit second parameters to the server.

In some embodiments, the techniques described herein for derived track selection and track switching can be used to enable track selection and switching, at run time, from an alternate track group and a switch track group, respectively for delivery to the client device. Therefore, a server can use a derived track that includes selection and switching derivation operations that allow the server to construct a single media track for the user based on the available media tracks (e.g., from among media tracks of different bitrates). Transformation operations are described herein that provide for track derivation operations that can be used to perform track selection and track switching at the sample level (e.g., not the track level). As described herein, a number of input tracks (e.g., tracks of different bitrates, qualities, etc.) can be processed by track selection derivation operations to select samples from one of the input tracks at the sample level to generate the media samples of the output track. Accordingly, the selection-based track derivation techniques described herein allow for the selection of samples from a track in a group of tracks at the time of the derivation operation. In some embodiments, the selection-based track derivation can provide for a track encapsulation of track samples as the output from the derivation operation(s) of a derived track, where the track samples are selected or switched from a group of tracks. As a result, a track selection derivation operation can provide samples from any of the input tracks to the derivation operation as specified by the transformations of the derived track to generate the resulting track encapsulation of the samples.

In the following description, numerous specific details are set forth regarding the systems and methods of the disclosed subject matter and the environment in which such systems and methods may operate, etc., in order to provide a thorough understanding of the disclosed subject matter. In addition, it will be understood that the examples provided below are exemplary, and that it is contemplated that there are other systems and methods that are within the scope of the disclosed subject matter.

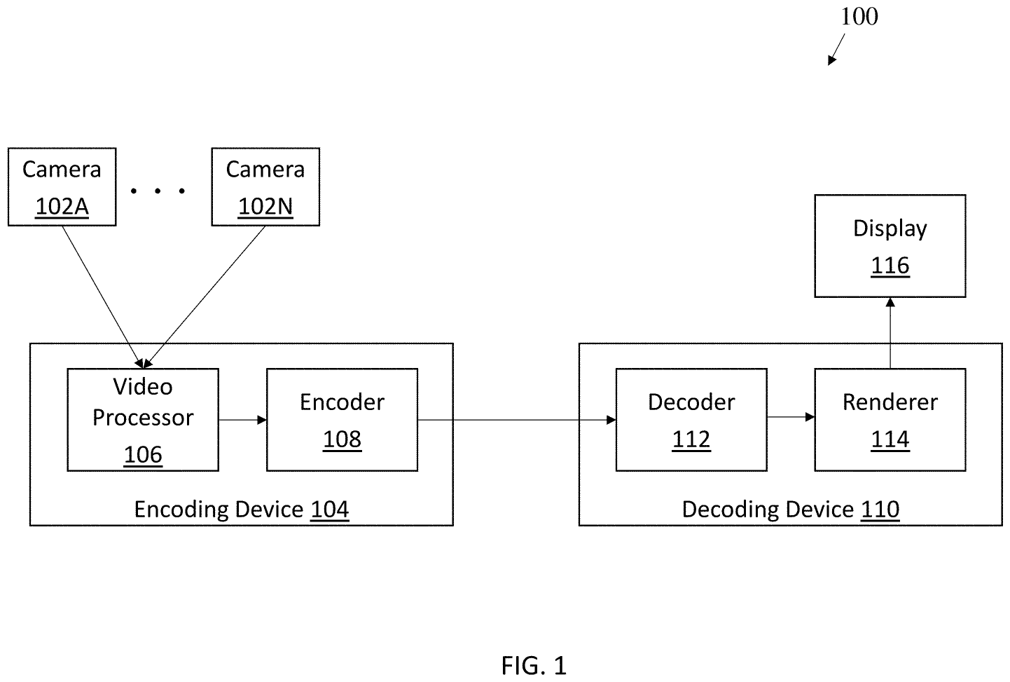

FIG. 1 shows an exemplary video coding configuration 100, according to some embodiments. Cameras 102A-102N are N number of cameras, and can be any type of camera (e.g., cameras that include audio recording capabilities, and/or separate cameras and audio recording functionality). The encoding device 104 includes a video processor 106 and an encoder 108. The video processor 106 processes the video received from the cameras 102A-102N, such as stitching, projection, and/or mapping. The encoder 108 encodes and/or compresses the two-dimensional video data. The decoding device 110 receives the encoded data. The decoding device 110 may receive the video as a video product (e.g., a digital video disc, or other computer readable media), through a broadcast network, through a mobile network (e.g., a cellular network), and/or through the Internet. The decoding device 110 can be, for example, a computer, a hand-held device, a portion of a head-mounted display, or any other apparatus with decoding capability. The decoding device 110 includes a decoder 112 that is configured to decode the encoded video. The decoding device 110 also includes a renderer 114 for rendering the two-dimensional content back to a format for playback. The display 116 displays the rendered content from the renderer 114.

Generally, 3D content can be represented using spherical content to provide a 360 degree view of a scene (e.g., sometimes referred to as omnidirectional media content). While a number of views can be supported using the 3D sphere, an end user typically just views a portion of the content on the 3D sphere. The bandwidth required to transmit the entire 3D sphere can place heavy burdens on a network, and may not be sufficient to support spherical content. It is therefore desirable to make 3D content delivery more efficient. Viewport dependent processing can be performed to improve 3D content delivery. The 3D spherical content can be divided into regions/tiles/sub-pictures, and only those related to viewing screen (e.g., viewport) can be transmitted and delivered to the end user.

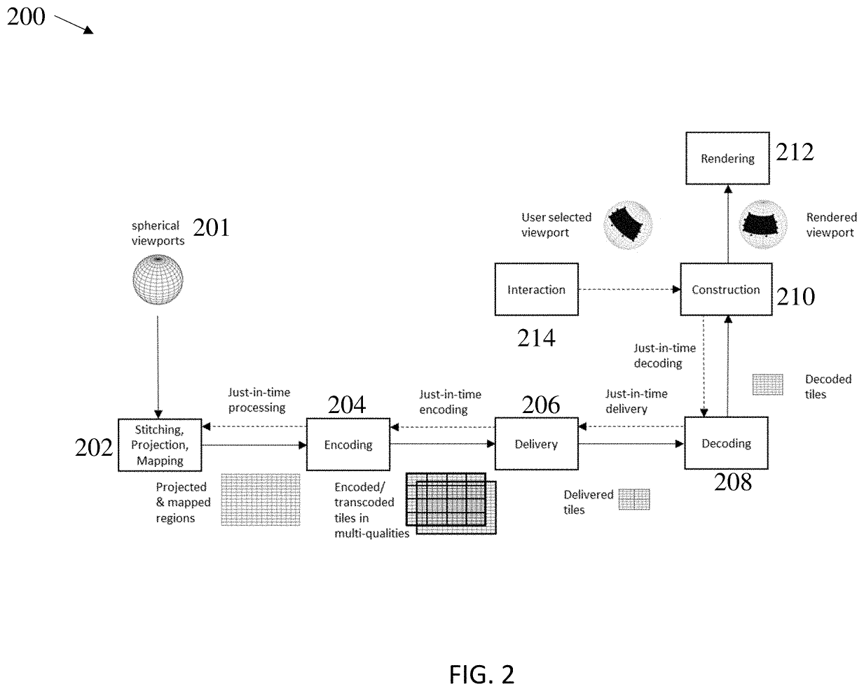

FIG. 2 shows a viewport dependent content flow process 200 for VR content, according to some examples. As shown, spherical viewports 201 (e.g., which could include the entire sphere) undergo stitching, projection, mapping at block 202 (to generate projected and mapped regions), are encoded at block 204 (to generate encoded/transcoded tiles in multiple qualities), are delivered at block 206 (as tiles), are decoded at block 208 (to generate decoded tiles), are constructed at block 210 (to construct a spherical rendered viewport), and are rendered at block 212. User interaction at block 214 can select a viewport, which initiates a number of “just-in-time” process steps as shown via the dotted arrows.

In the process 200, due to current network bandwidth limitations and various adaptation requirements (e.g., on different qualities, codecs and protection schemes), the 3D spherical VR content is first processed (stitched, projected and mapped) onto a 2D plane (by block 202) and then encapsulated in a number of tile-based (or sub-picture-based) and segmented files (at block 204) for delivery and playback. In such a tile-based and segmented file, a spatial tile in the 2D plane (e.g., which represents a spatial portion, usually in a rectangular shape of the 2D plane content) is typically encapsulated as a collection of its variants, such as in different qualities and bitrates, or in different codecs and protection schemes (e.g., different encryption algorithms and modes). In some examples, these variants correspond to representations within adaptation sets in MPEG DASH. In some examples, it is based on user's selection on a viewport that some of these variants of different tiles that, when put together, provide a coverage of the selected viewport, are retrieved by or delivered to the receiver (through delivery block 206), and then decoded (at block 208) to construct and render the desired viewport (at blocks 210 and 212).

As shown in FIG. 2, the viewport notion is what the end-user views, which involves the angle and the size of the region on the sphere. For 360 degree content, generally, the techniques deliver the needed tiles/sub-picture content to the client to cover what the user will view. This process is viewport dependent because the techniques only deliver the content that covers the current viewport of interest, not the entire spherical content. The viewport (e.g., a type of spherical region) can change and is therefore not static. For example, as a user moves their head, then the system needs to fetch neighboring tiles (or sub-pictures) to cover the content of what the user wants to view next.

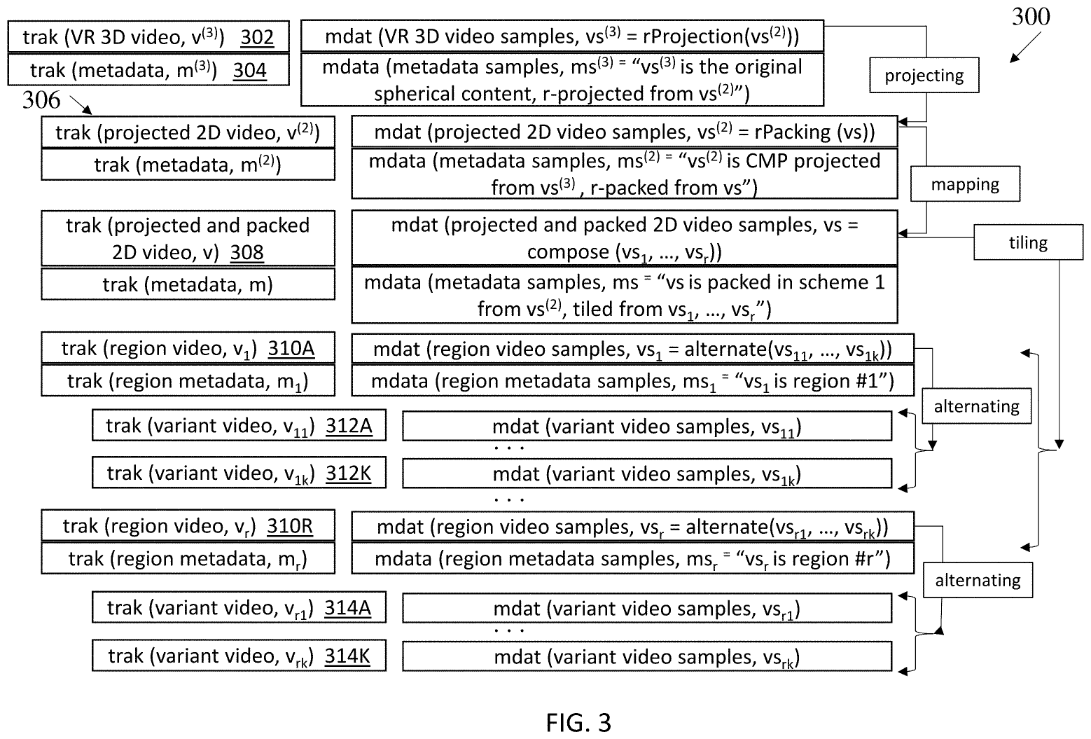

A flat file structure for the content could be used, for example, for a video track for a single movie. For VR content, there is more content than is sent and/or displayed by the receiving device. For example, as discussed herein, there can be content for the entire 3D sphere, where the user is only viewing a small portion. In order to encode, store, process, and/or deliver such content more efficiently, the content can be divided into different tracks. FIG. 3 shows an exemplary track hierarchical structure 300, according to some embodiments. The top track 302 is the 3D VR spherical content track, and below the top track 302 is the associated metadata track 304 (each track has associated metadata). The track 306 is the 2D projected track. The track 308 is the 2D big picture track. The region tracks are shown as tracks 310A through 310R, generally referred to as sub-picture tracks 310. Each region track 310 has a set of associated variant tracks. Region track 310A includes variant tracks 312A through 312K. Region track 310R includes variant tracks 314A through 314K. Thus, as shown by the track hierarchy structure 300, a structure can be developed that starts with physical multiple variant region tracks 312, and the track hierarchy can be established for region tracks 310 (sub-picture or tile tracks), projected and packed 2D tracks 308, projected 2D tracks 306, and VR 3D video tracks 302, with appropriate metadata tracks associated them.

In operation, the variant tracks include the actual picture data. The device selects among the alternating variant tracks to pick the one that is representative of the sub-picture region (or sub-picture track) 310. The sub-picture tracks 310 are tiled and composed together into the 2D big picture track 308. Then ultimately the track 308 is reverse-mapped, e.g., to rearrange some of the portions to generate track 306. The track 306 is then reverse-projected back to the 3D track 302, which is the original 3D picture.

The exemplary track hierarchical structure can include aspects described in, for example: m39971, “Deriving Composite Tracks in ISOBMFF”, January 2017 (Geneva, CH); m40384, “Deriving Composite Tracks in ISOBMFF using track grouping mechanisms”, April 2017 (Hobart, AU); m40385, “Deriving VR Projection and Mapping related Tracks in ISOBMFF;” m40412, “Deriving VR ROI and Viewport related Tracks in ISOBMFF”, MPEG 118^{th} meeting, April 2017, which are hereby incorporated by reference herein in their entirety. In FIG. 3, rProjection, rPacking, compose and alternate represent the track derivation TransformProperty items reverse ‘proj’, reverse ‘pack’, ‘cmpa’ and ‘cmp1’, respectively, for illustrative purposes and are not intended to be limiting. The metadata shown in the metadata tracks are similarly for illustrative purposes and are not intended to be limiting. For example, metadata boxes from OMAF can be used as described in w17235, “Text of ISO/IEC FDIS 23090-2 Omnidirectional Media Format,” 120th MPEG Meeting, October 2017 (Macau, China), which is hereby incorporated by reference herein in its entirety.

The number of tracks shown in FIG. 3 is intended to be illustrative and not limiting. For example, in cases where some intermediate derived tracks are not necessarily needed in the hierarchy as shown in FIG. 3, the related derivation steps can be composed into one (e.g., where the reverse packing and reverse projection are composed together to eliminate the existence of the projected track 306).

A derived visual track can be indicated by its containing sample entry of type ‘dtrk’. A derived sample contains an ordered list of the operations to be performed on an ordered list of input images or samples. Each of the operations can be specified or indicated by a Transform Property. A derived visual sample is reconstructed by performing the specified operations in sequence. Examples of transform properties in ISOBMFF that can be used to specify a track derivation, including those in the latest ISOBMFF Technologies Under Consideration (TuC) (see, e.g., N17833, “Technologies under Consideration for ISOBMFF”, July 2018, Ljubljana, SK, which is hereby incorporated by reference herein in its entirety), include: the ‘idtt’ (identity) transform property; the ‘clap’ (clean aperture) transform property; the ‘srot’ (rotation) transform property; the ‘dslv’ (dissolve) transform property; the ‘2dcc’ (ROI crop) transform property; the ‘tocp’ (Track Overlay Composition) transform property; the ‘tgcp’ (Track Grid Composition) transform property; the ‘tgmc’ (Track Grid Composition using Matrix values) transform property; the ‘tgsc’ (Track Grid Sub-Picture Composition) transform property; the ‘tmcp’ (Transform Matrix Composition) transform property; the ‘tgcp’ (Track Grouping Composition) transform property; and the ‘tmcp’ (Track Grouping Composition using Matrix Values) transform property. All of these track derivations are related to spatial processing, including image manipulation and spatial composition of input tracks.

Derived visual tracks can be used to specify a timed sequence of visual transformation operations that are to be applied to the input track(s) of the derivation operation. The input tracks can include, for example, tracks with still images and/or samples of timed sequences of images. In some embodiments, derived visual tracks can incorporate aspects provided in ISOBMFF, which is specified in w18855, “Text of ISO/IEC 14496-12 6^{th} edition,” October 2019, Geneva, CH, which is hereby incorporated by reference herein in its entirety. ISOBMFF can be used to provide, for example, a base media file design and a set of transformation operations. Exemplary transformation operations include, for example, Identity, Dissolve, Crop, Rotate, Mirror, Scaling, Region-of-interest, and Track Grid, as specified in w19428, “Revised text of ISO/IEC CD 23001-16 Derived visual tracks in the ISO base media file format,” July 2020, Online, which is hereby incorporated by reference herein in its entirety. Some additional derivation transformation candidates are provided in the TuC w19450, “Technologies under Consideration on ISO/IEC 23001-16,” July, 2020, Online, which is hereby incorporated by reference herein in its entirety, including composition and immersive media processing related transformation operations.

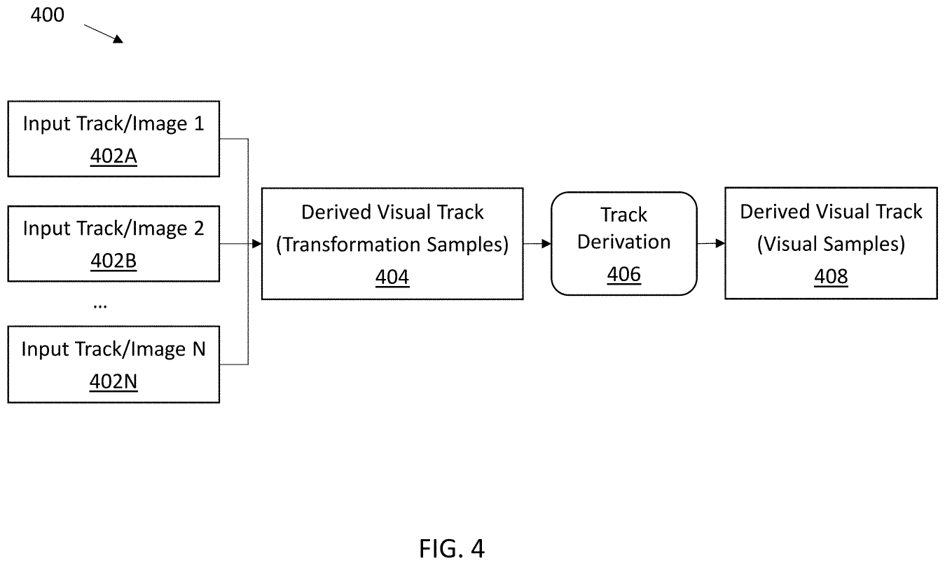

FIG. 4 shows an example of a track derivation operation 400, according to some examples. A number of input tracks/images one (1) 402A, two (2) 402B through N 402N are input to a derived visual track 404, which carries transformation operations for the transformation samples. The track derivation operation 406 applies the transformation operations to the transformation samples of the derived visual track 404 to generate a derived visual track 408 that includes visual samples.

Two track selection-based derivation transformations, namely “Selection of One” (‘sell’) and “Selection of Any” (‘seln’), were proposed in m39971, “Deriving Composite Tracks in ISOBMFF,” January 2017, Geneva, CH, which is hereby incorporated by reference herein in its entirety. However, both of these transformations were designed for the purpose of image composition of input tracks, and therefore require dimensional information for the composition operation.

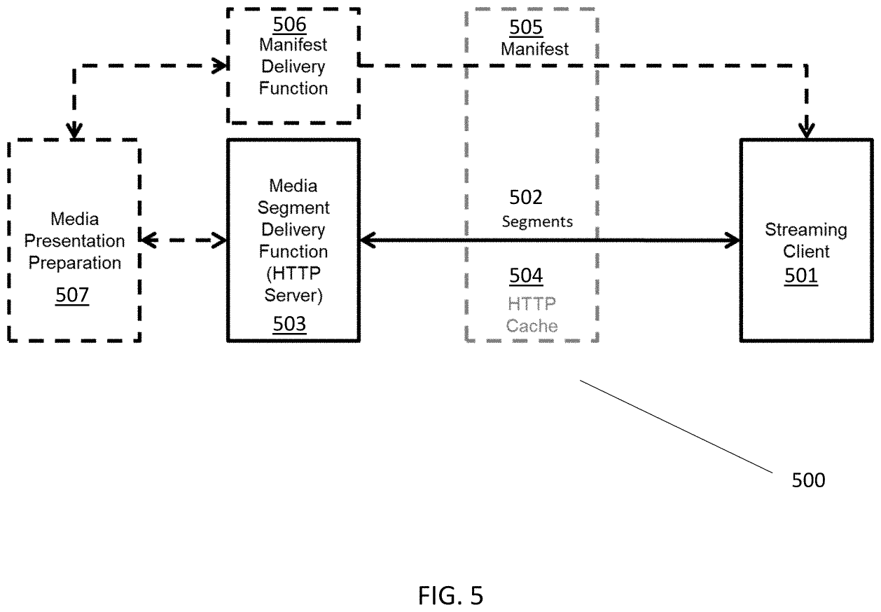

Conventional adaptive media streaming techniques rely on the client-device to perform any adaptation based on adaptation parameters that are available to the client. Not intending to be limiting, for ease of reference such techniques can be referred to generally as client-side streaming adaptation (CSSA), where a client device is responsible for performing streaming adaptation in adaptive media streaming systems. FIG. 5 shows an exemplary configuration of a generic adaptive streaming system 500, according to some embodiments. A streaming client 501 in communication with a server, such as HTTP server 503, may receive a manifest 505. The manifest 505 describes the content (e.g., video, audio, subtitles, bitrates, etc.). In this example, the manifest delivery function 506 may provide the streaming client 503 with the manifest 505. The manifest delivery function 506 and the server 503 may communicate with media presentation preparation module 507. The streaming client 501 can request (and receive) segments 502 from the server 503 using, for example, HTTP cache 504 (e.g., a server-side cache and/or cache of a content delivery network). The segments can be, for example, associated with short media segments, such as 6-10 second long segments. For further details of an illustrative example, see e.g., w18609, “Text of ISO/IEC FDIS 23009-1:2014 4th edition”, July 2019, Gothenburg, SE, which is hereby incorporated by reference herein in its entirety.

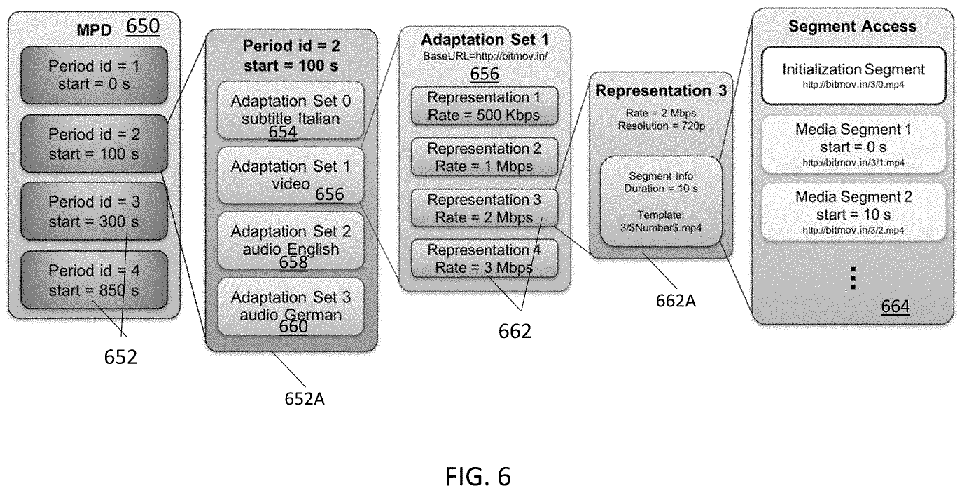

FIG. 6 shows an exemplary manifest that includes a media presentation description (MPD) 650, according to some examples. The manifest can be, for example, the manifest 605 sent to the streaming client 601. The MPD 650 includes a series of periods that divide the content into different time portions that each have different IDs and start times (e.g., 0 seconds, 100 seconds, 300 seconds, etc.). Each period can include a set of a number of adaptation sets (e.g., subtitles, audio, video, etc.). Period 652A shows how each period can have a set of associated adaptation sets, which in this example includes adaptation set 0 654 for Italian subtitles, adaptation set 1 656 for video, adaptation set 2 658 for English audio, and adaptation set 3 660 for German audio. Each adaptation set can include a set of representations to provide different qualities of the associated content of the adaptation set. As shown in this example, adaptation set 1 656 includes representations 1-4 662, each with a different supported bitrate (i.e., 500 Kbps, 1 Mbps, 2 Mbps, and 3 Mbps). Each representation can have segment information for the different qualities. As shown, for example, representation 3 652A includes segment info 664, which has a duration of 10 seconds and a template, as well as segment access 664, which includes an initialization segment, and a series of media segments (e.g., in this example, ten-second-long media segments).

In conventional adaptive streaming configurations, the streaming client, such as streaming client 501, implements the adaptation logic for streaming adaptation. In particular, the streaming client 501 can receive the MPD 650, and select (e.g., based on the client's adaptation parameters, such as bandwidth, CPU processing power, etc.) a representation for each period of the MPD (which may change over time, given different network conditions and/or client processing capabilities), and retrieve the associated segments for presentation to the user. As the client's adaptation parameters change, the client can select different representations accordingly (e.g., lower bitrate data if the available network bandwidth decreases and/or if client processing power is low, or higher bitrate data if the available bandwidth increases and/or if client processing power is high). The adaptation logic may include static as well as dynamic adaptation, in selecting segments from different media streams according to some adaptation parameters. This is described, for example, in “MPD Selection Metadata” of w18609, which is hereby incorporated by reference herein in its entirety.

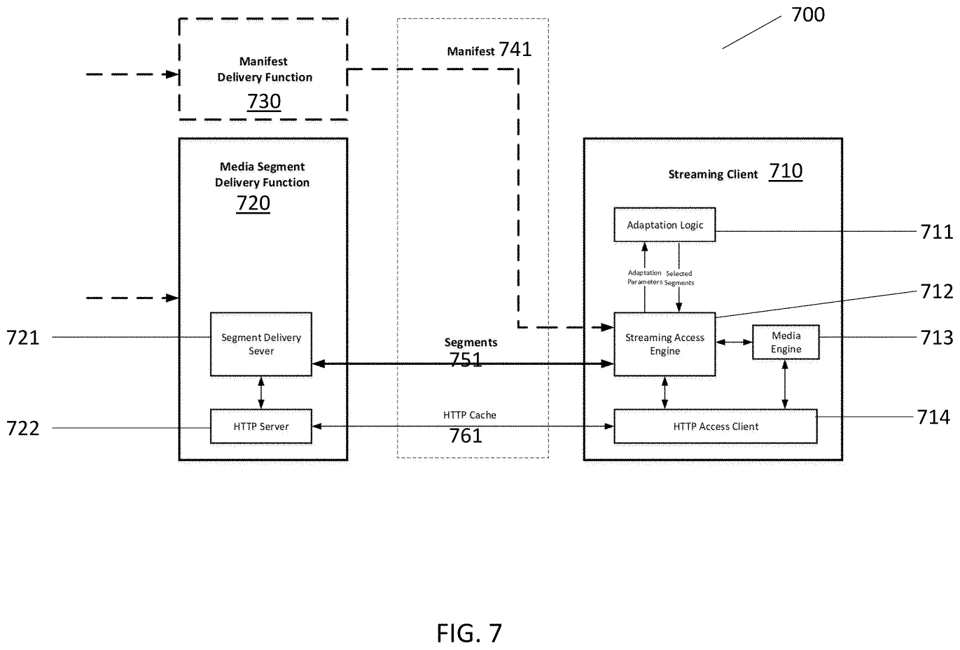

FIG. 7 shows an exemplary configuration 700 of a client-side dynamic adaptive streaming system. As described herein, the configuration 700 comprises a streaming client 710 in communication with server 722 via HTTP cache 761. The server 722 may be comprised in the media segment delivery function 720, which includes segment delivery server 721. The segment delivery server 721 is configured to transmit segments 751 to the streaming access engine 712. The streaming access engine further receives the manifest 741 from the manifest delivery function 730.

As described herein, in conventional configurations, the client device 710 performs the adaptation logic 711. The client device 710 receives the manifest via the manifest delivery function 730. The client device 710 also receives adaptation parameters from streaming access engine 712 and transmits requests for the selected segments to the streaming accessing engine 712. The streaming access engine is also in communication with media engine 713.

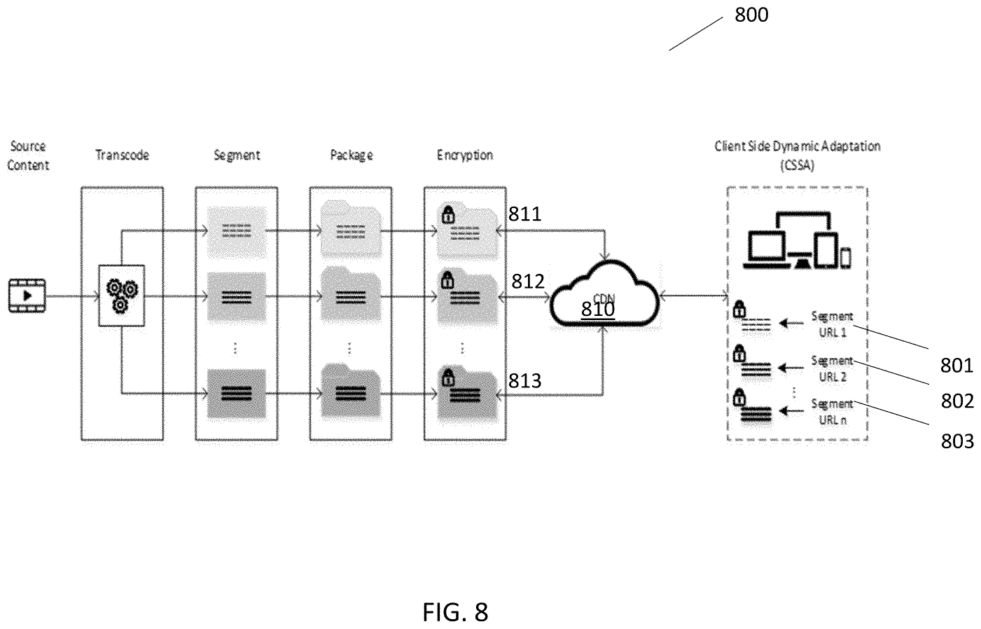

FIG. 8 shows an example of end-to-end streaming media processing, according to some embodiments. In the end-to-end streaming media processing flow 800, the client performs the adaptation logic that performs streaming adaptation in terms of selecting (e.g., encrypted) segments from a set of available streams 811, 812, and 813, for example, the segment URLs 801-803. As such, each of the encrypted segments 801, 802, and 803 are transmitted via the content delivery network (CDN) 810 and are all transmitted to the client device. The client device may then select the segments.

There are deficiencies with conventional client-side streaming adaptation approaches. In particular, such paradigms are designed so that the client both obtains the information needed for content adaptation (e.g., adaptation parameters), receives a full description of all available content and associated representations (e.g., different bitrates), and processes the available content to select among the available representations to find the one that best suits the client's adaptation parameters. The client has to further repeatedly perform the process over time, including updating the adaptation parameters and selecting the same and/or different representations depending on the updated parameters. Accordingly, a heavy burden is placed on the client, and it requires the client device to have sufficient processing capabilities. Further, such configurations often require the client to make a number of requests in order to start a streaming session, including (1) obtaining a manifest and/or other description of the available content, (2) requesting an initialization segment, and (3) then requesting content segments. Accordingly, such approaches often require three or more calls. Assuming for an illustrative example that each call takes approximately 500 ms, the initiation process can consume one or more seconds of time.

For some types of content, such as immersive media, the client is required to perform compute-intensive operations. For example, conventional immersive media processing delivers tiles to the requesting client. The client device therefore needs to construct a viewport from the decoded tiles in order to render the viewport to the user. Such construction and/or stitching can require a lot of client-side processing power. Further, such approaches may require the client device to receive some content that is not ultimately rendered into the viewport, consuming unnecessary storage and bandwidth.

In some embodiments, the techniques described herein provide for server-side selection and/or switching of media tracks. Not intending to be limiting, for ease of reference such techniques can be referred to generally as server-side streaming adaptation (SSSA), where a server may perform aspects of streaming adaptation that are otherwise conventionally performed by the client device. Accordingly, the techniques provide for a major paradigm shift compared to conventional approaches. In some embodiments, the techniques can move some and/or most of the adaptation logic to the server, such that the client can simply provide the server with appropriate adaptation information and/or parameters, and the server can generate an appropriate media stream for the client. As a result, the client processing can be reduced to receiving and playing back the media, rather than also performing the adaptation.

In some embodiments, the techniques provide for a set of adaptation parameters. The adaptation parameters can be collected by clients and/or networks and communicated to the servers to support server-side content adaptation. For example, the parameters can support bitrate adaptation (e.g., for switching among different available representations). As another example, the parameters can provide for temporal adaptation (e.g., to support trick plays). As a further example, the techniques can provide for spatial adaptation (e.g., viewport and/or viewport dependent media processing adaptation). As another example, the techniques can provide for content adaptation (e.g., for pre-rendering, storyline selection, and/or the like).

In some embodiments, the techniques described herein for derived track selection and track switching can be used to enable track selection and switching, at run time, from an alternate track group and a switch track group, respectively for delivery to the client device. Therefore, a server can use a derived track that includes selection and switching derivation operations that allow the server to construct a single media track for the user based on the available media tracks (e.g., from among media tracks of different bitrates). See also, for example, the derivations included in e.g., m54876, “Track Derivations for Track Selection and Switching in ISOBMFF”, October 2020, Online, which is hereby incorporated by reference herein in its entirety.

In some embodiments, the available tracks and/or representations can be stored as separate tracks. As described herein, transformation operations can be used to perform track selection and track switching at the sample level (e.g., not the track level). Accordingly, the techniques described herein for derived track selection and track switching can be used to enable track selection and switching, at run time, from a group of available media tracks (e.g., tracks of different bitrates) for delivery to the client device. Therefore, a server can use a derived track that includes selection and switching derivation operations that allow the server to construct a single media track for the user based on the available media tracks (e.g., from among media tracks of different bitrates) and the client's adaptation parameters. For example, the track selection and/or switching can be performed in a manner that selects from among the input tracks to determine which of the input tracks best-suits the client's adaptation parameters. As a result, a number of input tracks (e.g., tracks of different bitrates, qualities, etc.) can be processed by track selection derivation operations to select samples from one of the input tracks at the sample level to generate the media samples of the output track that are dynamically adjusted to meet the client's adaptation parameters as they change over time. As described herein, in some embodiments, the selection-based track derivation can encapsulate track samples as the output from the derivation operation(s) of a derived track. As a result, a track selection derivation operation can provide samples from any of the input tracks to the derivation operation as specified by the transformations of the derived track to generate the resulting track encapsulation of the samples. The resulting (new) track can be transmitted to the client device for playback.

In some embodiments, the client device can provide spatial adaptation information, such as spatial rendering information to the server. For example, in some embodiments the client device can provide viewport information (on a 2D, spherical and/or 3D viewport) to the server for immersive media scenarios. The server can use the viewport information to construct the viewport for the client at the server-side, instead of requiring the client device to perform the stitching and construction of the (the 2D, spherical or 3D) viewport. Accordingly, spatial media processing tasks can be moved to the server-side of adaptive streaming implementations.

In some embodiments, the client can provide other adaptation information, including temporal and/or content-based adaptation information. For example, the client can provide bitrate adaptation information (e.g., for representation switching). As another example, the client can provide temporal adaptation information (e.g., such as for trick plays, low-latency adaptation, fast-turn-ins, and/or the like). As a further example, the client can provide content adaptation information (e.g., for pre-rendering, storyline selection and/or the like). The server-side can be configured to receive and process such adaptation information to provide the temporal and/or content-based adaptation for the client device.

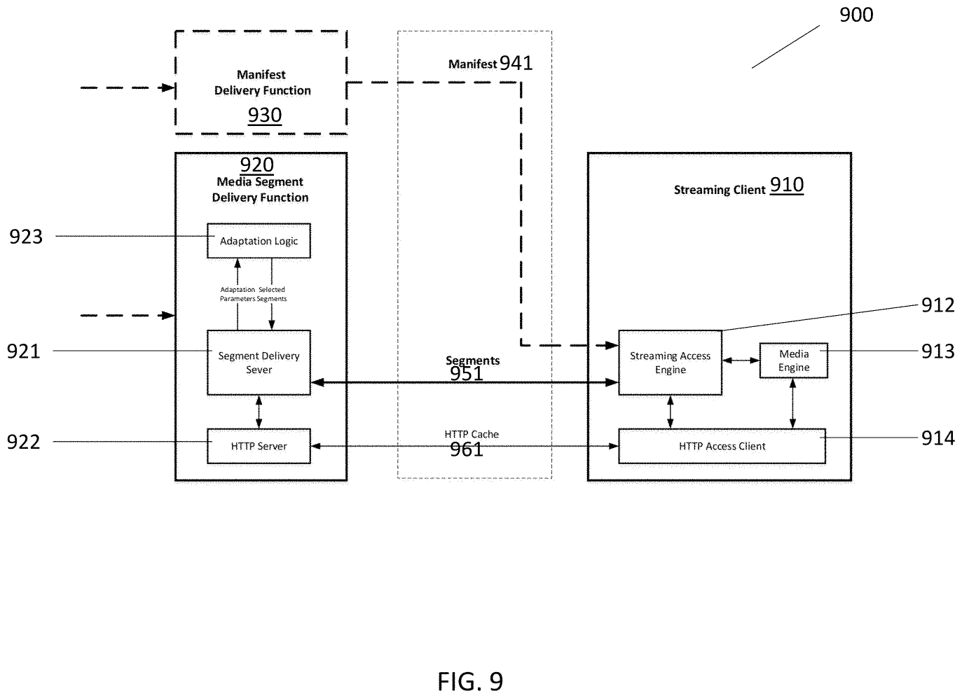

For example, FIG. 9 shows an exemplary configuration of a server-side adaptive streaming system, according to some embodiments. As described herein, the configuration 900 includes a streaming client 910 in communication with server 922 via HTTP cache 961. The streaming client 910 includes a streaming access engine 912, a media engine 913, and an HTTP access client 914. The server 922 may be included as part of the media segment delivery function 920, which includes segment delivery server 921. The segment delivery server 921 is configured to transmit segments 951 to the streaming access engine 912 of the streaming client 910. The streaming access engine 912 also receives the manifest 941 from the manifest delivery function 930. Unlike in the example of FIG. 7, the client device does not perform the adaptation logic to select among the available representations and/or segments. Rather, the adaptation logic 923 is incorporated in the media delivery function 920 so that the server-side performs the adaptation logic to dynamically select content based on client adaptation parameters. Accordingly, the streaming client 910 can simply provide adaptation information and/or adaptation parameters to the media segment delivery function 920, which in-turn performs the selection for the client. In some embodiments as described herein, the streaming client 910 can request a general (e.g., placeholder) segment that is associated with the content stream the server generates for the client.

As described further herein, the adaptation parameters can be communicated using various techniques. For example, the adaptation parameters can be provided as query parameters (e.g., URL query parameters), HTTP parameters (e.g., as HTTP header parameters), SAND messages (e.g., carrying adaptation parameters collected by the client and/or other devices), and/or the like. An example of URL query parameters can include, for example: $bitrate=1024, $2D_viewport_x=0, $2D_viewport_y=0, $2D_viewport_width=1024, $2D_viewport_height=512, etc. An example of HTTP header parameters can include, for example: bitrate=1024, 2D_viewport_x=0, 2D_viewport_y=0, 2D_viewport_width=1024, 2D_viewport_height=512, etc.

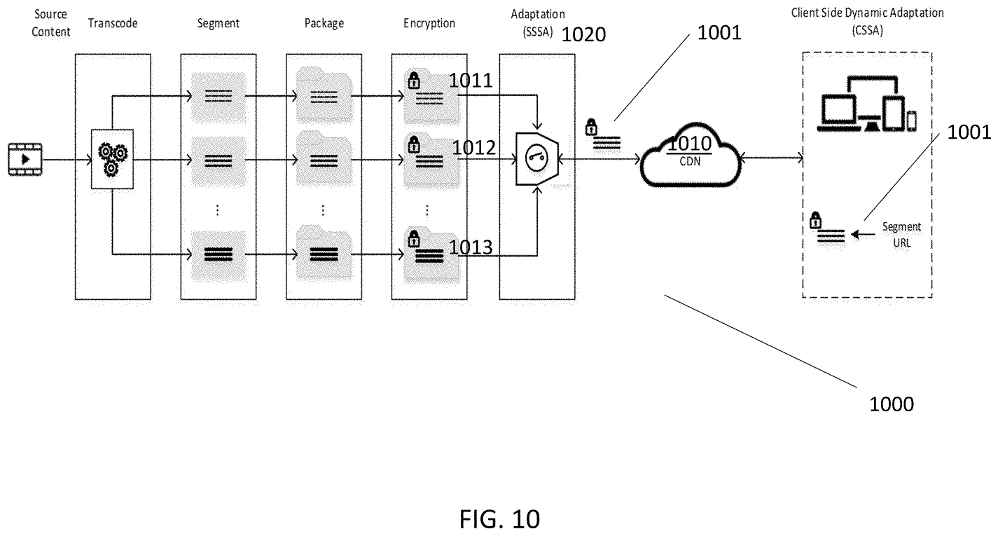

FIG. 10 shows an example of end-to-end streaming media processing using server-side adaptive streaming, according to some embodiments. In the end-to-end streaming media processing flow 1000, the server performs some and/or all of the adaptation logic that is used to select (e.g., encrypted) segments from a set of available streams as discussed herein, rather than the client device as in the example for CSDA in FIG. 8. For example, the server device can perform adaptation 1020 to select segments from the set of available streams 1011-1013. The server device may select, for example, the segment 1001. The segment 1001 may be transmitted from the server to the client device via the content delivery network (CDN) accordingly. As shown, the client device can therefore use a single URL as discussed herein to obtain the content from the server (rather than multiple URLs as is typically required for client-side configurations in order to differentiate between different formats of available content (e.g., different bitrates).

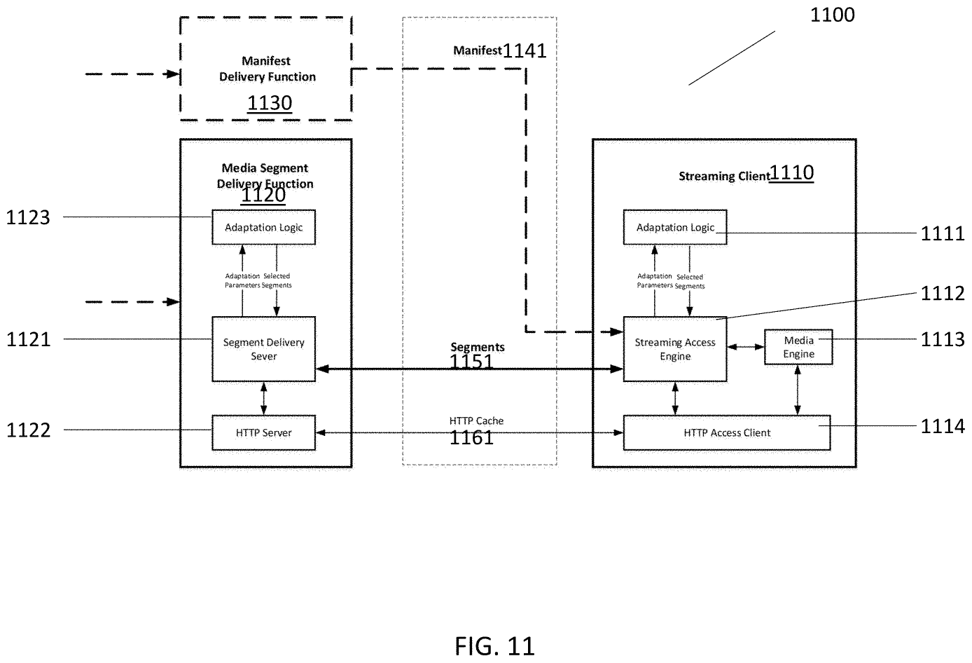

FIG. 11 shows an exemplary configuration of a mixed side adaptive streaming system, according to some embodiments. The configuration 1100 comprises a streaming client 1110 in communication with server 1122 via HTTP cache 1161. The streaming client 1110 includes adaptation logic 1120, streaming access engine 1112, media engine 1113, and HTTP access client 1113. The server 1122 may be part of the media segment delivery function 1120, which includes segment delivery server 1121 and the adaptation logic 1110. The segment delivery server 1121 is configured to transmit segments 1151 to the streaming client 1110's streaming access engine 1112. The streaming access engine 1112 further receives the manifest 1141 from the manifest delivery function 1130.

Both the media segment delivery function 1120 and the client device 1110 perform an associated portion of the adaptation logic, as demonstrated by the media segment delivery function 1120 including adaptation logic 1123 and the streaming client 1110 including adaptation logic 1111. Accordingly, the client device 1110 receives and/or determines the adaptation parameters via streaming access engine 1112, determines a (e.g., first) segment from an available set of segments presented in the manifest 1141, and transmits a request for the segment to the segment delivery server 1121. The streaming client 1110 can also be configured to determine and update adaptation parameters over time, and to provide the adaptation parameters to the server so that the media segment delivery function 1120 can continue to perform adaptation over time for the streaming client 1110.

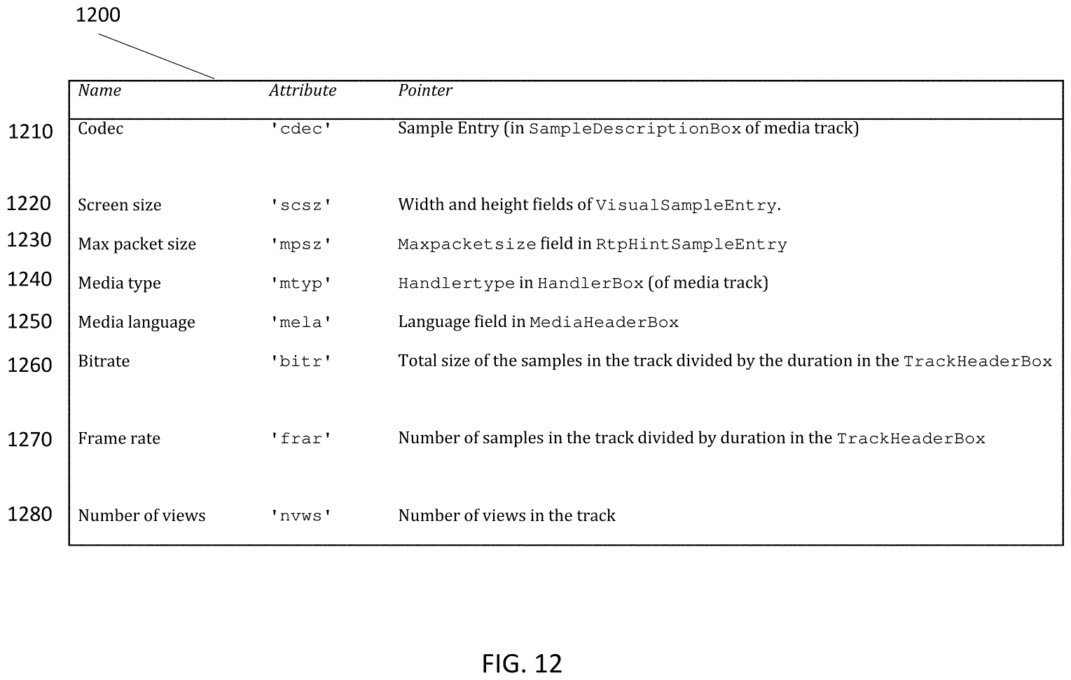

FIG. 12 shows a list of parameters 1200 for operations such as track selection or switching, according to some embodiments. The list of parameters includes codec 1210, screen size 1220, max packet size 1230, media type 1240, media language 1250, bitrate 1260, frame rate 1270 and number of views 1280. The parameter codec 1210 may be represented by ‘cdec’ 1211 and may be a sample entry (e.g., in SampleDescriptionBox of media track). The parameter screen size 1220 may be represented by ‘scsz’ 1221 and may include width and height fields of VisualSampleEntry. The parameter max packet size 1230 may be represented by ‘mpsz’ 1231 and may be the maximum packet size (e.g., Maxpacketsize field in RtpHintSampleEntry). The parameter media type 1240 may be represented by ‘mtyp’ 1241 and may be a handling type (e.g., Handlertype in HandlerBox (of media track)). The parameter media language 1250 may be represented by ‘mela’ 1251 and may be a language field in MediaHeaderBox for designating language. The parameter bitrate 1260 may be represented by ‘bitr’ 1261 and may be the total size of the samples in the track divided by the duration in the TrackHeaderBox. The parameter frame rate 1270 may be represented by ‘frar’ 1271 and may be a number of samples in the track divided by duration in the TrackHeaderBox. The parameter number of views 1280 may be represented by ‘nvws’ 1281 and may be the number of views in the track. It should be appreciated that the names, attributes, and other conventions discussed in conjunction with FIG. 12 are for exemplary purposes and can be used with various implementations. For example, one or more of these parameters can be used with DASH, possibly with different names, and can be in the DASH namespace. A DASH device may select tracks based on its screen size in client-side dynamic adaptation. For server-side dynamic adaptation, the server may require knowledge of the client's screen size.

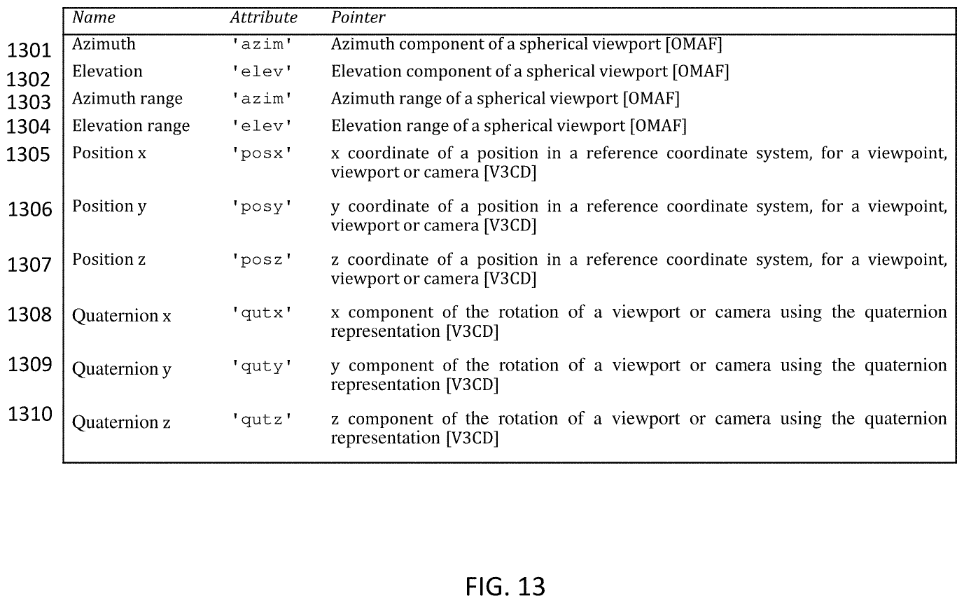

FIG. 13 shows exemplary viewport and viewpoint related data structure attributes, according to some embodiments. The attributes include azimuth 1301, elevation 1302, azimuth range 1303, elevation range 1304, position x 1305, position y 1306, position z 1307, and quaternion x 1308, quaternion y 1309 and quaternion z 1310.

The attribute azimuth 1301 may be represented by ‘azim’ and may be an azimuth component of a spherical viewport. The attribute elevation 1302 may be represented by ‘elev’ and may be an elevation component of a spherical viewport. The attribute azimuth range 1303 may be represented by ‘azim’ and may be an azimuth range of a spherical viewport. The attribute elevation range 1304 may be represented by ‘elev’ and may be an elevation range of a spherical viewport.

The attribute position x 1305 may be represented by ‘posx’ and may be the x coordinate of a position in a reference coordinate system, for a viewpoint, viewport or camera. The attribute position y 1306 may be represented by ‘posy’ and may be the y coordinate of a position in a reference coordinate system, for a viewpoint, viewport or camera. The attribute position z 1307 may be represented by ‘posz’ and may be the z coordinate of a position in a reference coordinate system, for a viewpoint, viewport or camera.

The attribute quaternion x 1308 may be represented by ‘qutx’ and may be the x component of the rotation of a viewport or camera using the quaternion representation. The attribute quaternion y 1309 may be represented by ‘quty’ and may be the y component of the rotation of a viewport or camera using the quaternion representation. The attribute quaternion z 1310 may be represented by ‘qutz’ and may be the z component of the rotation of a viewport or camera using the quaternion representation.

There can be various problems with conventional VR streaming approaches. For example, when VR content is delivered using streaming protocols (e.g., MPEG DASH), the use cases typically require temporal signaling so that the client can request content, including for specific qualities, etc. Such requests may require multiple distinct calls to the server. For example, conventional methods may require a first request for a manifest (e.g., so that the client can determine the available data, quality/bitrates, structure of the data, etc.), a second request for an initialization segment, and a further third request for the immersive content itself. Such a messaging configuration can take multiple seconds before the client device renders content. This can be further compounded by the fact that the immersive content calls can, in-turn, require multiple calls. For example, when using content partitioned into tiles, a client device may need to request content for each tile (e.g., if there are multiple tiles, each tile may require a separate request). Accordingly, such messaging can require significant overhead. Additionally, such approaches can require buffer management, require resources for viewport generation, stitching, rendering, and/or the like.

Further, conventional approaches may not provide sufficient features for robust user experiences. For example, while FIG. 13 shows examples of 3DoF parameters (parameters 1301-1304) and 6DoF parameters (parameters 1305-1310), such parameters are limited. For example, the 6DoF parameters do not provide for a size, rather just a point for the content and an associated orientation.

Accordingly, conventional techniques are limited and do not address desired use case scenarios. Further, it can be difficult for a client to request content from a live stream and the client may experience latency due to the multiple calls, complicated requests, content transmission delays created by the requisite multiple calls, etc.

It can therefore be desirable to provide for techniques that support new and improved use cases for web-based content streaming, such as for DASH streaming applications. In some embodiments, the techniques provide temporal adaptation parameters, which can be used for various use cases, such as for joining live events, fast turning into streams, and/or the like. The techniques can use the temporal adaptation parameters described herein to consolidate (the otherwise requisite, multiple) calls of conventional approaches for faster tuning in to content. In some examples, client devices may request content with only one call (or fewer calls than otherwise required by conventional techniques) and receive, in response to the one call, consolidated data (e.g., data comprising the manifest, initialization segment, and one or more segments of the immersive content).

Further, a method for clients to request live content may be desirable. When a device tunes to a stream of media data (e.g., a channel), the client device may not know the latest segment that the server has for live content. As a result, it can be difficult for a client to determine the last segment for live content. The techniques described herein provide temporal adaptation techniques that allow the server to provide live content when a client accesses a live stream of media data. In some examples, the client can simply indicate to the server that it wishes to join live, and the server can send the client the newest/latest segments that are available to the server.

In some embodiments, the techniques can additionally or alternatively provide spatial adaptation parameters for viewport and viewpoint selection, to include 2D spatial object selection (e.g., as specified in DASH). For example, DASH can provide some 2D spatial objects. The techniques described herein can provide support for 2D spatial object selection, which was not otherwise available for conventional streaming approaches.

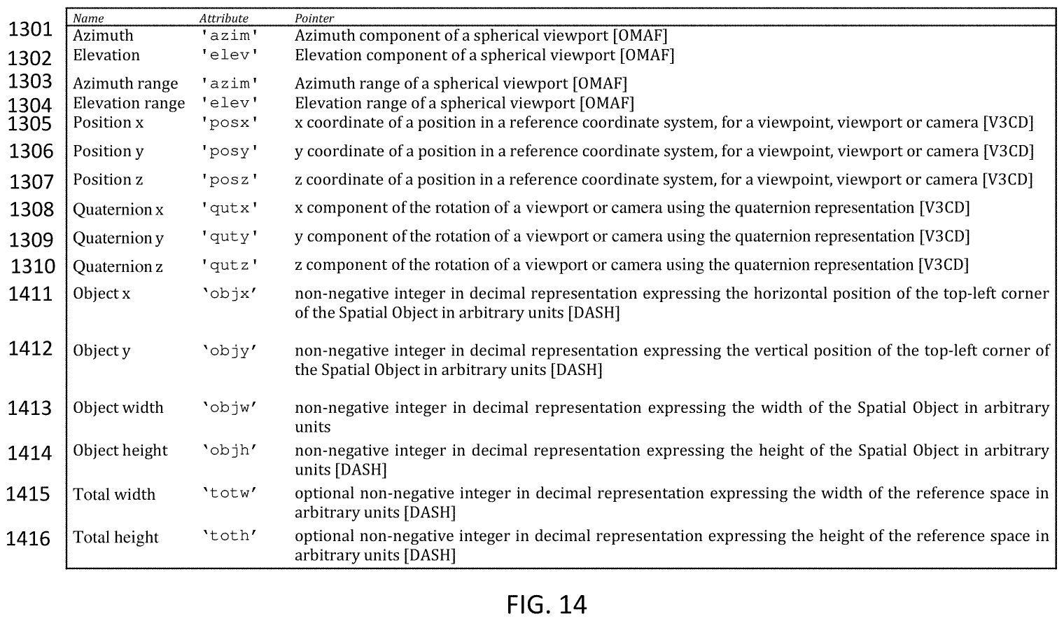

FIG. 14 shows an exemplary list of viewport, viewpoint, and spatial-object related data structure attributes for spherical, cuboid, and planar regions, according to some embodiments. In particular, the examples shown include spatial-object related data for planar regions, which was not supported by conventional techniques and thus not possible to implement (e.g., not possible to implement in a DASH framework). The attributes include the attributes described with reference to FIG. 13 (shown as azimuth 1401, elevation 1402, azimuth range 1403, elevation range 1404, position x 1405, position y 1406, position z 1407, and quaternion x 1408, quaternion y 1409 and quaternion z 1410), with additional attributes for 2D planar regions. The attributes include object x 1411, object y 1412, object width 1413, object height 1414, total width 1415 and total height 1416. The attribute object x 1411 may be represented by ‘objx’ and may be a non-negative integer in decimal representation expressing the horizontal position of the top-left corner of the Spatial Object in arbitrary units. The attribute object y 1412 may be represented by ‘objy’ and may be a non-negative integer in decimal representation expressing the vertical position of the top-left corner of the Spatial Object in arbitrary units. The attribute object width 1413 may be represented by ‘objw’ and may be a non-negative integer in decimal representation expressing the width of the Spatial Object in arbitrary units. The attribute object height 1414 may be represented by ‘objh’ and may be a non-negative integer in decimal representation expressing the height of the Spatial Object in arbitrary units.

The attribute total width 1415 may be represented by ‘totw’ and may be a optional non-negative integer in decimal representation expressing the width of the reference space in arbitrary units. The attribute total height 1416 may be represented by ‘toth’ and may be an optional non-negative integer in decimal representation expressing the height of the reference space in arbitrary units.

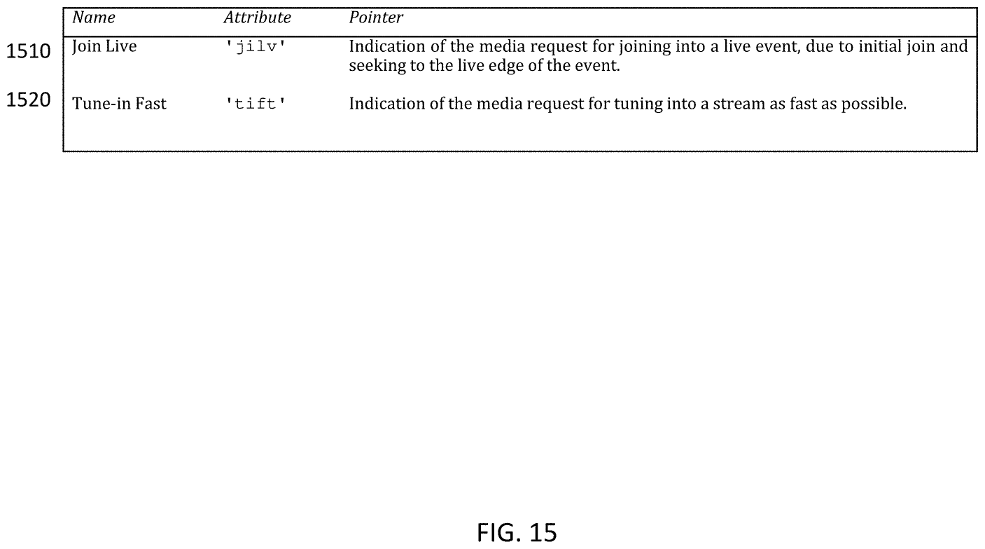

FIG. 15 shows an exemplary list of temporal adaptation related attributes that may be used by a client device to indicate to the server if a media request is for tuning into a live event or stream (e.g., channel) or joining fast into a stream. According to some examples, the attribute Join Live 1510 may be represented by a string ‘jilv’ and may indicate a media request for joining into a live event, due to initial join and seeking to the live edge of the event. According to some examples, the attribute Tune-in Fast 1520 may be represented by a string ‘tift’ and may indicate a media request for turning into a stream as fast as possible.

Such exemplary temporal adaptation related attributes can be used for various use cases. For example, temporal adaptation related attributes can be used where the client needs to indicate to the server if a media request is for turning into a live event (or stream of media data) (e.g., as discussed in m56798. “Shortening tune-in time,” April 2021, the contents of which are incorporated herein in its entirety), or joining fast into a stream (e.g., as discussed in m56673, “Minimizing initialization delay in live streaming,” April 2021, the contents of which are incorporated herein in its entirety), and/or the like. The attributes may allow the server to respond accordingly, such as for low-latency, on-demand, fast start-up, good experience start up scenarios, and/or the like.

For example, the attributes may allow low latency by adaptively returning a sub-segment or a CMAF chunk on a live edge (e.g., as discussed in AWS Media Blog, “Lower latency with AWS Elemental MediaStore chunked object transfer,” available at aws.amazon.com/blogs/media/lower-latency-with-aws-elemental-mediastore-chunked-object-transfer/, the contents of which are incorporated herein in its entirety). For example, for live content a client may not know the live edge segment, rather just the server may know. As a result, a client may request content for a particular time, and the server may respond that the content is not available (e.g., since there can be latency with content still being captured). Also need to transcode, etc. As a result, the client may request content for an older time period, which the server may have, although in doing so the client may skip over more recent content that is available between the two content request periods (although the client has no way of knowing). As a result, it is not uncommon for a client to not have the newest live segment, which can add latency, cause issues when there are multiple devices (e.g., which may render content at different times for the same live stream), and/or the like. As a result, the techniques can address such problems by simply allowing the client to join and having the server send the most recently available segment of data.

As another example, the attributes may allow content on-demand by adaptively returning a regular segment for on-demand content, for example, when the attribute “Join Live” is either omitted or set to be FALSE. As a further example, the attributes may allow a fast start-up by adaptively returning one or more low-quality initial segments, possibly in conjunction with an initialization segment. As an additional example, the attributes may allow good-experience start-up by adaptively returning one or more high-quality initial segments to ensure a good viewing experience from the very beginning, when the attribute “Join Fast” is either omitted or set to be FALSE.

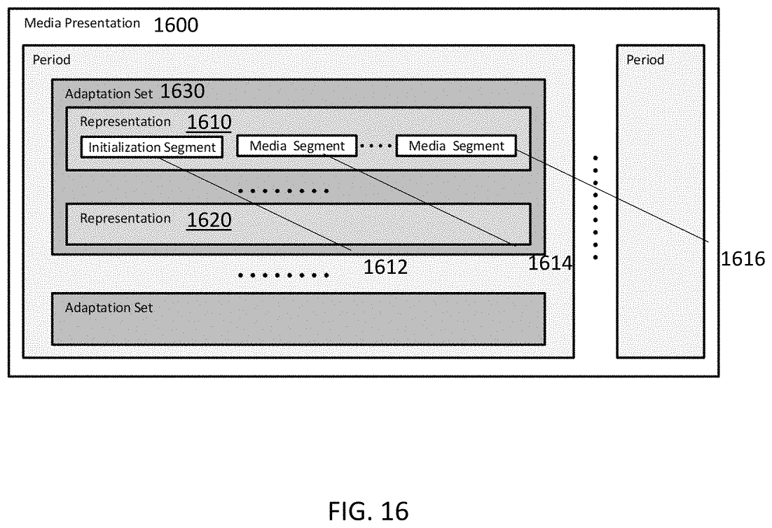

In both the server-side and mixed-side configurations, a media presentation description can be exchanged as discussed herein. FIG. 16 shows an example of a media presentation description with periods with multiple representations in an adaptation set for conventional client-side adaptive streaming, according to some embodiments. As shown (e.g., and as discussed in conjunction with FIG. 7B), the adaptation set of each period may include multiple representations shown as representation 1610 through representation 1620 in this example. Each representation, such as shown for representation 1610 may include an initialization segment 1612, and a set of media segments (shown as 1614 through 1616, in this example).

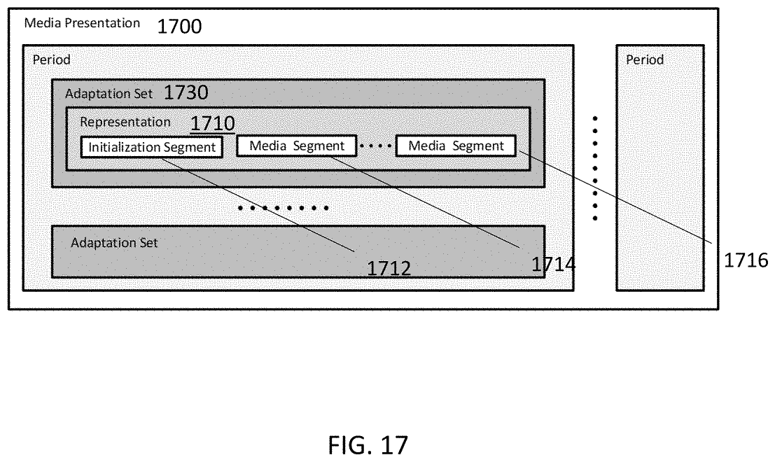

In some embodiments, for server-side and/or mixed-side configurations, the adaptation set can be modified such that each adaptation set only includes one representation. FIG. 17 shows an example of a single representation 1710 in an adaptation set 1730 for server-side adaptive streaming, according to some embodiments. Compared to the media presentation description 1600 of FIG. 16, for server-side streaming adaptation, a single representation 1710 may be included for each adaptation set 1730 in the media presentation description 1700 rather than multiple representations. This is possible since the client device is not performing the logic to select from among available representations, and therefore the client need not be aware of any differentiation among different content qualities, etc. In some embodiments, the media presentation description 1600 may be used for mixed-side configurations where the client performs some adaptation processing in conjunction with the server performing some adaptation processing (e.g., where the client selects an initial representation and/or subsequent representations). In some embodiments, the single representation 1710 may include a URL to a derived track containing the derivation operations to generate an adapted track based on the client's (adaptation) parameters. The client device may then access the generic URL and provide the parameters to the server, such that the server can construct the track for the client. In some embodiments, the same and/or different URLs can be used for the initialization segment 1612 and media segments 1614. For example, the URLs can be the same if, for example, the client passes different adaptation parameters to the server to differentiate between the two different kinds of requests, such as by using one set of parameter(s) for initialization and another set of parameter(s) for segments. As another example, different URLs can be used for the initialization and media segments (e.g., to differentiate between and/or among the different segments). The client can continuously request segments using the single representation, and hence the single generic URL.

Server-side adaptation can result in bandwidth reductions as well as reductions in overall content processing that may otherwise be required for some types of content, such as for immersive media. Referring back to FIG. 2, for example, FIG. 2 shows the viewport dependent content flow process 200 for virtual reality (VR) content for server-side streaming adaptation. As described, spherical viewports 201 undergo stitching, projection, mapping at block 202, are encoded at block 204, are delivered at block 206, and are decoded at block 208. The client device constructs (210) the media for the user's viewport (e.g., from a set of applicable tiles and/or tile tracks) to render (212) the content for the user's viewport to the user. When using server-side streaming adaptation, the construction process can be performed at the server-side instead of the client side (e.g., thus reducing and/or eliminating the processing otherwise required to be performed by the client device at block 210). For example, by shifting the adaptation and track generation to the server-side, the construction process 210 can be avoided since the exact content can be generated at the server-side, reducing the processing burden of the decoder and saving bandwidth since the associated tile tracks often include additional content not rendered onto the user's viewport. For example, the client can provide viewport information to the server (e.g., a position of the viewport, a shape of the viewport, a size of the viewport, and/or the like) to request video from the server that covers the viewport. The server can use the received viewport information to deliver the associated set of media for just the viewport and perform spatial adaptation for the client device.

Generally, the techniques described herein provide for server-side adaptation approaches. In some embodiments, derived composition, selection and switch tracks can be used to implement SSSA, as opposed to client-side streaming adaptation CSSA, in adaptive streaming systems, for viewport-dependent media processing. Derived composition, selection and switch tracks are described in, for example, m54876, “Track Derivations for Track Selection and Switching in ISOBMFF”, October 2020 (Online), w19961, “Study of ISO/IEC 23001-16 DIS,” January 2021 (Online), and w19956, “Technologies under Consideration of ISO/IEC 23001-16,” January 2021 (Online), which are hereby incorporated by reference herein in their entirety.

As described herein, for various reasons immersive media processing usually adopts a viewport dependent approach. 3D spherical content, for example, is first processed (stitched, projected and mapped) onto a 2D plane and then encapsulated in a number of tile-based and segmented files for playback and delivery. In such a tile-based and segmented file, a spatial tile or sub-picture in in the 2D plane, often representing a rectangular spatial portion of the 2D plane, is encapsulated as a collection of its variants (such as variants that support different qualities and bitrates, or in different codecs and protection schemes). Such variants can, for example, correspond to representations within adaptation sets in MPEG DASH. It is based on user's selection on a viewport that some of these variants of different tiles that, when put together, provide a coverage of the selected viewport, are retrieved by or delivered to the receiver, and then decoded to construct and render the desired viewport.

Other content can have similar high-level schemes. For example, when VR content is delivered using MPEG DASH, the use cases typically require signaling of viewports and ROIs within an MPD for the VR content, so that the client can help the user to decide which, if any, viewports and ROIs to delivery and render. As another example, for immersive media content beyond omnidirectional content (e.g., point-cloud and 3D immersive video), a similar viewport-dependent approach can be used for its processing, where a viewport and a tile are a 3D viewport and 3D region, instead of a 2D viewport and a 2D sub-picture.

Accordingly, the client is required to perform computationally expensive construction processes for various types of media. In particular, since the content is divided into regions/tiles/etc., the client is left to choose which portions(s) will be used to cover the client's viewport. In practice, what the user is viewing is possibly only a small portion of the content. The server also needs to make the content, including the portions/tiles, available to the client. Once client chooses something different (e.g., based on bandwidth), or once user moves and viewport changes, then client needs to ask for different regions. Since the client needs to perform multiple downloads and/or retrievals for the various tiles and/or representations as discussed herein, for each sub-picture or tile, the client may need to make a number of separate requests (e.g., separate HTTP requests, such as four requests for four different tiles associated with a viewport).

It can be desirable to remove some and/or all of the construction process from the client side (e.g., step 210 discussed in conjunction with FIG. 2). In particular, performing construction on the client side can require tile stitching on-the-fly at the client side (e.g., which can require seamless stitching of tile segments, including with tile boundary padding). Construction on the client side can also require the client to perform consistent quality management for retrieved and stitched tile segments (e.g., to avoid stitching of tiles of different qualities). Additionally or alternatively, construction on the client side can also require that the client perform tile buffering management (e.g., including having the client attempt to predict the user's movement without downloading of un-necessary tiles). Construction on the client side may additionally or alternatively require the client to perform viewport generation of 3D Point Cloud and Immersive Video (e.g., including constructing the viewport from compressed component video segments).

To address these and other issues, the techniques described herein move spatial media processing from the client to the server. In some embodiments, the client passes spatially-related information (e.g., viewport-related information) to the server so that the server can perform some and/or all of the spatial media processing. For example, if the client needs an X×Y region, the client can simply pass to the server the position and/or size of the viewing field, and the server can determine the requested region and perform the construction process to stitch the relevant tiles to cover the requested viewport, and only deliver the stitched content back to the client. As a result, the client only needs to decode and render the delivered content. Further, when the viewport changes, the client can send new viewport information to the server, and the server can change the delivered content accordingly. As a result, instead of needing to determine which tiles to use to construct the viewport, instead clients can send the viewport information to the server, and the server can process and generate a single viewport segment for the client. Such approaches can address the various deficiencies mentioned above, such as reducing and/or eliminating the need for the client to perform on-the-fly stitching, quality management, tile buffer management, and/or the like. Further, if the content is encrypted, such approaches can simply the encryption since it only need be performed on the client-customized media.

According to some embodiments, in the SSSA approach described herein, a set of dynamic adaptation parameters can be collected by clients or networks and communicated to servers. For example, the parameters may include DASH or SAND parameters, and may be used to support bitrate adaptation such as representation switching (e.g., as described in w18609, “Text of ISO/IEC FDIS 23009-1:2014 4th edition,” July 2019, Gothenburg, SE and w16230, “Text of ISO/IEC FDIS 23009-5 Server and Network Assisted DASH,” June 2016, Geneva, CH, both incorporated by reference herein in their entirety), temporal adaptation (e.g., such as trick plays described in w18609), spatial adaptation such as viewport/viewpoint dependent media processing (e.g., such as described in w19786, “Text of ISO/IEC FDIS 23090-2 2nd edition OMAF,” ISO/IEC JTC 1/SC 29/WG 3, October 2020 and WG03N0163, “Draft text of ISO/IEC FDIS 23090-10 Carriage of Visual Volumetric Video-based Coding Data,” January 2021, Online both described herein in their entirety), and content adaptation such as pre-rendering and storyline selection (e.g., such as described in w19062, “Text of ISO/IEC FDIS 23090-8 Network-based Media Processing,” January 2020, Brussels, BE referenced herein in its entirety).

Upon receiving these parameters, the server may conduct dynamic adaptations, such as the spatial adaptations for constructing viewports that the client would construct in the CSSA approach, based on parameters collected from clients and networks. Because of processing power of the server and the trend in cloud computing, this SSSA approach may be more advantageous over conventional dynamic adaptations by clients for viewport-dependent media processing.

In some embodiments, selection and switch tracks discussed herein can be used to enable streaming adaptation at the server side. In particular, since selection and switch tracks enable track selection and switching, at run time, from an alternate track group and a switch track group, respectively, streaming adaptation can be performed at the server side, instead of the client side, to simplify Streaming Client implementation.

Since selection-based track derivation can provide for selection of samples of a track from an alternate or switch group at the time of derivation, various improvements can be achieved. For example, such derivation can provide a track encapsulation for track samples selected or switched from an alternate or switch group. Such a track encapsulation can provide straightforward association of metadata about a selected or switched track with its track encapsulation itself, rather than with a track group from which the track is selected or switched. For example, in order to specify a track selected from a track group at run time has a region of interest (ROI), the ROI can be easily signaled in the metadata box (‘meta’) of the derived track (e.g., when the ROI is static) and/or a timed metadata track can be used to reference the derived track (e.g., using reference type ‘cdsc’, when the ROI is dynamic). In contrast, there is no direct way to signal the ROI metadata without a derived track: signaling a static ROI in the metadata box of every track in an alternate or switch group does not convey the same meaning as it instead conveys that every track has the static ROI. Additionally, having a timed metadata track representing a dynamic ROI to reference an alternate or switch group needs to specify a new track reference type, as the existing track reference in the track reference box states, when it applies to referencing a track group, “the track reference applies to each track of the referenced track group individually”, which is not a desired result.

The derived track encapsulation can also enable specifications and executions of track-based media processing workflows, such as in network based media processing, to use derived tracks not just as outputs but also intermediate inputs in the workflows.

The derived track encapsulation can also provide for track selection or switching to be transparent to clients of dynamic adaptive streaming, such as DASH, and carried out at corresponding servers or within distribution networks (e.g., implemented in conjunction SAND). This can help simplify client logics and implementations with respective to shifting dynamic content adaptation from the streaming manifest level to the file format derived track level (for instance, based on the descriptive and differentiating attributes specified in sub-clause 8.3.3 in w18855). With selection-based derived tracks, DASH clients and DASH aware network elements (DANE) can provide values of attributes (e.g., codec ‘cdec’, screen size ‘scsz’, bitrate ‘bitr’) required in the derived tracks, and let media origin servers and CND's provide content selection and switching from a group of available media tracks. This may then result in, for example, eliminating use of AdaptationSet and/or restricting its use to just containing a single Representation in DASH.

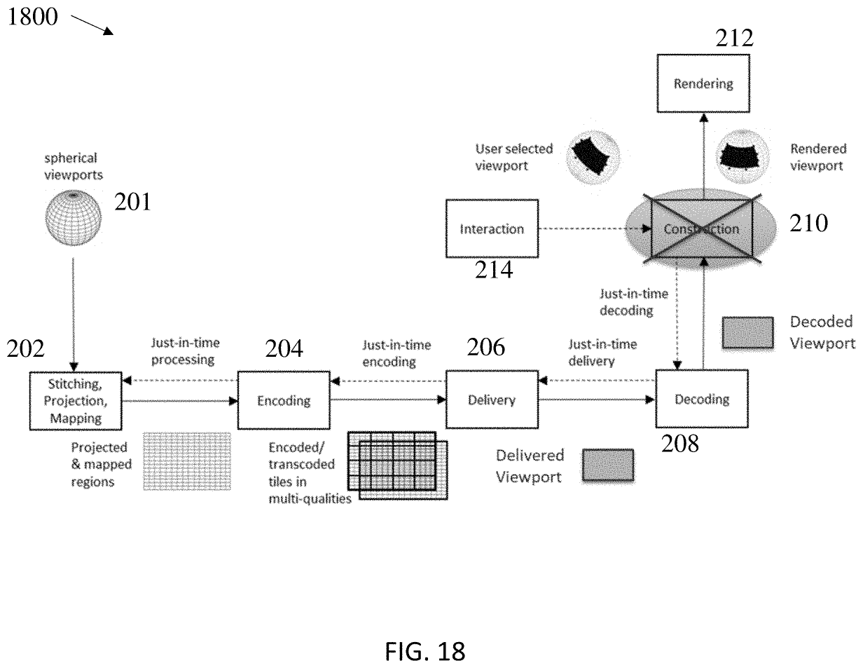

FIG. 18 shows the viewport dependent content flow process 200 for VR content for a server-side streaming adaptation, according to some examples. As described herein, spherical viewports 201 (e.g., which could include the entire sphere) undergo stitching, projection, mapping at block 202 (to generate projected and mapped regions), are encoded at block 204 (to generate encoded/transcoded tiles in multiple qualities), are delivered at block 206 (as tiles), and are decoded at block 208 (to generate decoded tiles). As shown in FIG. 18, the spherical viewports may not need to be constructed at block 210 (to construct a spherical rendered viewport, such as when the construction is performed by the server as described herein), and therefore the content may proceed to be rendered at block 212. As in 200, user interaction at block 214 can select a viewport, which initiates a number of “just-in-time” process steps as shown via the dotted arrows.

In some embodiments, the SSSA techniques described herein can be used within a network based media processing framework. For example, in some embodiments the viewport construction can be considered as one or more network-based functions (e.g., in addition to other functions, such as 360 stitching, 6DoF pre-rendering, guided transcoding, e-sports streaming, OMAF packager, measurement, MiFiFo buffer, ltoN splits, Ntol merges, etc.).

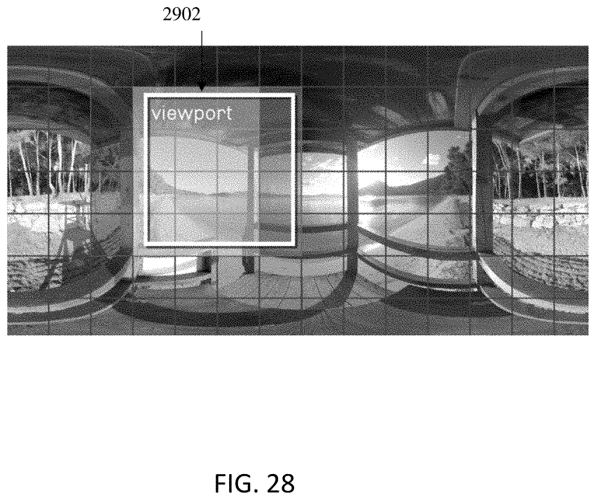

The techniques described herein are generally directed to media rendering adaptation, where streaming clients and/or servers can split rendering content, such as background or foreground content. In some embodiments, the techniques can be used for viewport dependent immersive media processing. FIG. 28 depicts an exemplary tile (e.g., sub-picture) based viewport 2902 dependent media processing for omnidirectional media content.

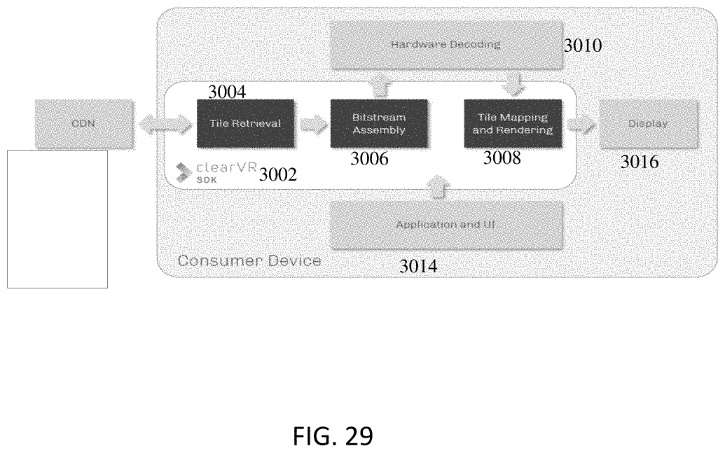

FIG. 29 illustrates an exemplary client architecture for viewport dependent immersive media processing. This exemplary architecture on a consumer device includes a software development toolkit (SDK) 3002 including tile retrieval 3004, bitstream assembly 3006, and tile mapping and rendering 3008. Hardware decoding 3010 is performed on the output of bitstream assembly 3006. The output of hardware decoding 3010 is the input to tile mapping and rendering 3008. The output of tile mapping and rendering 3008 is shown on display 3016. This exemplary architecture includes an Application and User Interface (UI) 3014.

The inventors have appreciated that complexities in client implementations, such as that shown in FIGS. 28-29, can include: (i) determination of which tiles and what qualities to retrieve, based on a user's viewport and network conditions, according to a streaming DASH manifest; (ii) multiple (e.g., 16) HTTP requests for the determined tile segments; (iii) consistent segment quality and buffer managements cross the determined tile segments; (iv) spatial stitching of retrieved tile segments to construct a viewport coverage for display, and/or the like.

Challenges can include, for example: (i) latency due to multiple HTTP requests and client-side viewport related management and processing; (ii) power consumption requirements for battery powered mobile devices; (iii) high-level security requirement (e.g., Widevine DRM Li) when each tile segment is separately encrypted and the viewport related management and processing need to be carried out within a Trusted Execution Environment (TEE), and/or the like.

For other types of immersive media content (e.g., point-cloud, 3D immersive video, and scene descriptions), similar complexities and challenges exist, such as due to the needs for: (i) partial access of volumetric visual data (including point cloud and 3D immersive video) with several video components per object in, e.g., clause 9 of MDS20307_WG03_N00241, “Text of ISO/IEC FDIS 23090-10 Carriage of Visual Volumetric Video-based Coding Data,” April 2021, which is hereby incorporated by reference herein in its entirety; (ii) multiple object/component 3D scenes with individual object/component retrieval in, e.g., FIGS. 1, 2 and 6 of MDS20898_WG03_N00421, “Draft text of ISO/IEC FDIS 23090-14 Scene Description for MPEG Media,” October 2021, which is hereby incorporated by reference herein in its entirety; and (iii) video decoding interfaces for immersive media in, for example, buffer synchronization and bitstream merging functions in MDS20897_WG03_N00420, “Draft text of ISO/IEC DIS 23090-13 Video Decoding Interface for Immersive Media,” October 2021, which is hereby incorporated by reference herein in its entirety.

The inventors have appreciated that, on the other hand, using SSDA or the split rendering of the present invention, a 2D/3D viewport, for example, can be dynamically selected or generated on the server side with a single HTTP request as (encrypted) segments of a single track, without multiple (e.g., 16) HTTP requests and tile stitching at the client side. This can simplify client implementations, and resolves some of the complexities and challenges identified above, especially those relating to multiple track encapsulated immersive media content.

The techniques described herein provide for HTTP parameters, which can be standardized, to support server-side dynamic adaptation, as opposed to client-side dynamic adaptation, in adaptive streaming systems. The server-side dynamic adaptation can, for example, be for rendering adaptation for split rendering, along with track adaptation for track/segment switching and selection, spatial adaptation for viewport/viewpoint selection, and temporal adaptation for join live and tune-in fast. In some embodiments, the scope of HTTP adaptation parameters to support SSDA (e.g., for DASH) can be limited to providing messages and parameters exchanged between clients and servers for the purpose of enabling SSDA (e.g., without requiring definitions of normative server-side adaptation behaviors). SSDA can be implemented using, for example, Derived Visual Tracks, through NBMP, and/or the like.

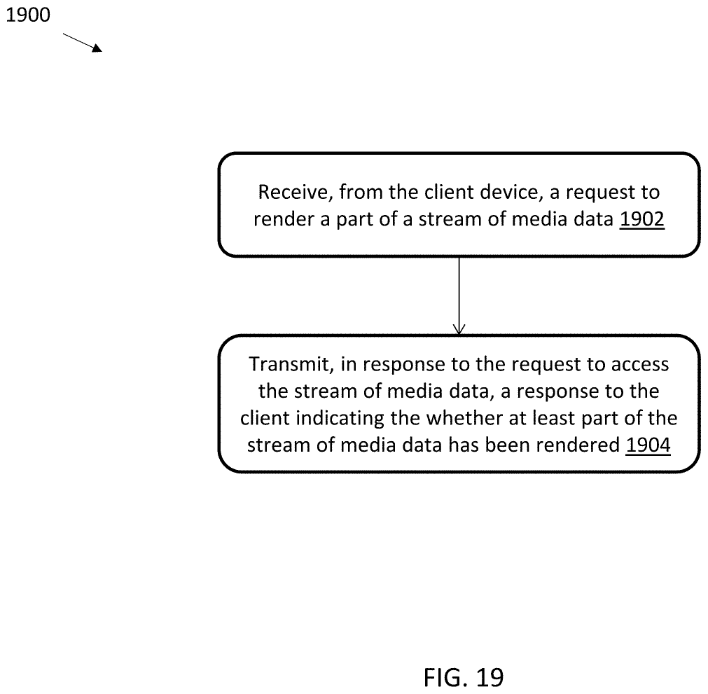

FIG. 19 shows an exemplary computerized method 1900 for a server in communication with a client device, according to some embodiments. At step 1902, the server receives, from the client device, a request to access a stream of media data (e.g., a channel or other source of media data) associated with immersive content. The request can be at a point in time the client is first accessing the stream of media data for the immersive content. The immersive content may be, for example, stored content or live immersive content. For live content, for example, the point in time is the latest time of the immersive content that the server possesses (e.g., live-edge content).

According to some examples, the request to access the stream is an HTTP request (e.g., a Dynamic Adaptive Streaming over HTTP request (DASH), an HTTP live streaming (HLS) request, etc.) and is transmitted by the client device prior to receiving any manifest data for the immersive media content from the server (e.g., when the client device is first tuning into a stream/channel/content). In some examples, the request for the portion of media data comprises one or more parameters of the client device (e.g., for use by the server). In some examples, the one or more parameters comprise a three-dimensional size of a viewport of the client device. In some embodiments, the received request at step 1902 can be the first message received from the client for the associated content. At step 1904, the server transmits, in response to the request to access the stream of media data, a response to the client indicating whether at least part of the stream of media data has been rendered.

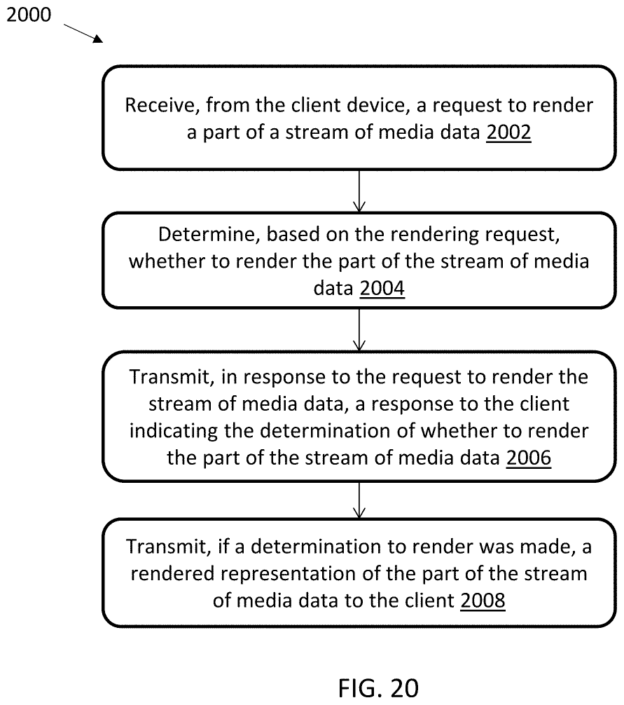

FIG. 20 shows an exemplary computerized method 2000 for a server in communication with a client device, according to some embodiments. At step 2002, the server receives, from the client device, a request to render a part of a stream of media data (e.g., a channel or other source of media data) associated with immersive content. As described herein, the immersive content may be, for example, live immersive content. The request can be, for example, at a point in time that is the latest time of the immersive content that the server possesses (e.g., live-edge content). As another example, the immersive content may not be live content.

At step 2004, the server determines, based on the rendering request, whether to render the part of the stream of media data. At step 2006, the server transmits, in response to the request to access the stream of media data, a response to the client indicating the determination of whether to render the part of the stream of media data. At step 2008, the server transmits, if a determination to render was made, a rendered representation of the part of the stream of media data to the client.

In some embodiments, the stream of media data may have a plurality of layers of media data. For example, the layers of media data may comprise a foreground layer, a background layer, or both. The rendering request can include a request to render a particular layer, such as a request to render a foreground layer, a background layer, and/or another layer.

In some embodiments, the server may also receive, from the client device, an updated rendering request. For example, the updated rendering request may comprise a request to not render the stream of media data, a request to render an additional part of the stream of media data, and/or a request to compose rendered content. As described herein, a client device can make adjustments over time, which can cause the client to transmit the updated request(s) (e.g., based on changes in battery, resource usage, network conditions, etc.).

In some embodiments, the step 2004 of determining, based on the rendering request, whether to render the at least part of the stream of media data may include determining to render at least part of the stream of media data. The server can render at least part of the stream of media data to produce a rendered representation of that part of the stream of media data, and transmitting this rendered representation to the client at step 2008. In some embodiments, the step 2004 of determining, based on the rendering request, whether to render at least part of the stream of media data may comprise determining not to render the part of the stream of media data.

In some embodiments, the server may also receive, from the client device, a first set of one or more parameters associated with a viewport of the client device, and may render at least part of the stream of media data (e.g., at step 2006) in accordance with the first set of one or more parameters to produce a rendered representation of the part of the stream of media data. Optionally, the server may transmit the rendered representation of the part of the stream of media data to the client.

In some embodiments, the first set of one or more parameters may comprise one or more of an azimuth, an elevation, an azimuth range, an elevation range, a position, and a rotation. For example, the position may comprise three dimensional rectangular coordinates. As another example, the rotation may comprise three rotational components in a three-dimensional rectangular coordinate system.

In some embodiments, the server may also receive, from the client device, a second set of one or more parameters associated with a spatial, planar object. Optionally, the step of rendering at least part of the stream of media data (e.g., at step 2006) may be done in accordance with both the first set of parameters and the second set of parameters. For example, the second set of parameters can include one or more of a position of a portion of the object, a width of the object, and a height of the object. As an example, the position of the portion of the object may comprise a horizontal position of a top left corner of the object and a vertical position of the top left corner of the object. Optionally, the width of the object and/or the height of the object may have arbitrary units.

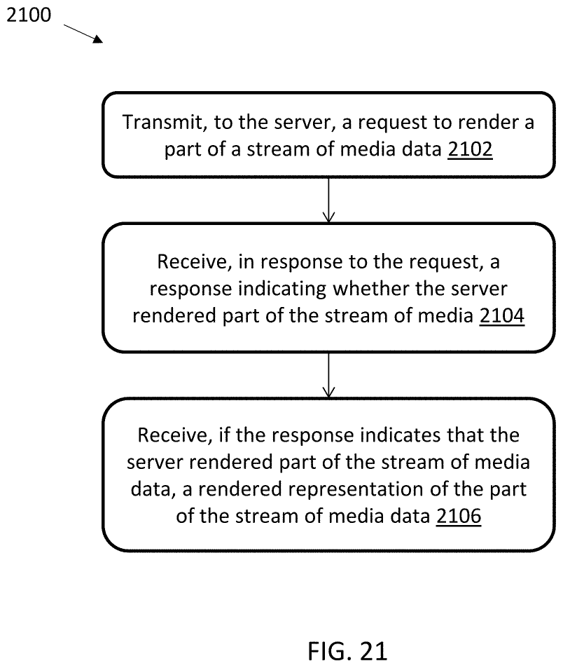

FIG. 21 shows an exemplary computerized method 2100 for a client device in communication with a server, according to some embodiments. At step 2102, the client device transmits, to the server, a request to render a part of a stream of media data. At step 2104, the client device receives, in response to the request, a response indicating whether the server rendered part of the stream of media. At step 2106, the client device receives, if the response indicates that the server rendered part of the stream of media data, a rendered representation of the part of the stream of media data.

In some embodiments, the part of the stream of media data may have a plurality of layers of media data. For example, the plurality of layers of media data may comprise a foreground layer or a background layer or both. The rendering request can include a request to render a particular layer, such as a request to render a foreground layer, a background layer, and/or another layer.

In some embodiments, the client device also transmits, to the server, an updated rendering request. For example, the update rendering request may comprise a request to not render the at least part of the stream of media data, a request to render all of the stream of media data, or a request to compose rendered content.

In some embodiments, if the response from the server indicates that the server did not render at least part of the stream of media data, the client device may render a representation of the part of the stream of media data. In some embodiments, the client device may also transmit, to the server, a first set of one or more parameters associated with a viewport of the client device. In some embodiments, if the response from the sever indicates that the server rendered part of the stream of media data, the client device may receive, from the server, a rendered representation of the part of the stream of media data in accordance with the first set of one or more parameters. For example, the first set of one or more parameters may comprise one or more of an azimuth, an elevation, an azimuth range, an elevation range, a position, and a rotation. As an example, the position may comprise three dimensional rectangular coordinates. As another example, the rotation may comprise three rotational components in a three-dimensional rectangular coordinate system.

In some embodiment, the client may also transmit, to the server, a second set of one or more parameters associated with a spatial, planar object. In some embodiments, if the response from the server indicates that the server rendered part of the stream of media data, the client device may receive, from the server, a rendered representation of the part of the stream of media data in accordance with the first set of one or more parameters and the second set of one or more parameters. For example, the second set of one or more parameters may comprise one or more of a position of a portion of the object, a width of the object, and a height of the object. As an example, the position of a portion of the object may comprise a horizontal position of a top left corner of the object and a vertical position of the top left corner of the object. As another example, the width of the object and/or the height of the object may have arbitrary units.

In some embodiments, a system is configured to provide video data for immersive media and comprises a processor in communication with memory, wherein the processor is configured to execute instructions stored in the memory that cause the processor to receive a request to access a stream of media data associated with immersive content. The request can include a rendering request for the server to render at least part of the stream of media data prior to transmission of the part of the stream of media data. In some embodiments, the processor may execute additional instructions stored in the memory to cause the processor to determine, based on the rendering request, whether to render the part of the stream of media data; and may transmit, in response to the request to access the stream of media data, a response indicating the determination.

In some embodiments, the instructions to determine, based on the rendering request, whether to render the at least part of the stream of media data may cause the processor to determine to render the part of the stream of media data; to render the part of the stream of media data to produce a rendered representation of the part of the stream of media data; and to transmit the rendered representation of the part of the stream of media data. In some embodiments, the instructions to determine, based on the rendering request, whether to render the at least part of the stream of media data may cause the processor to determine not to render the at least part of the stream of media data.

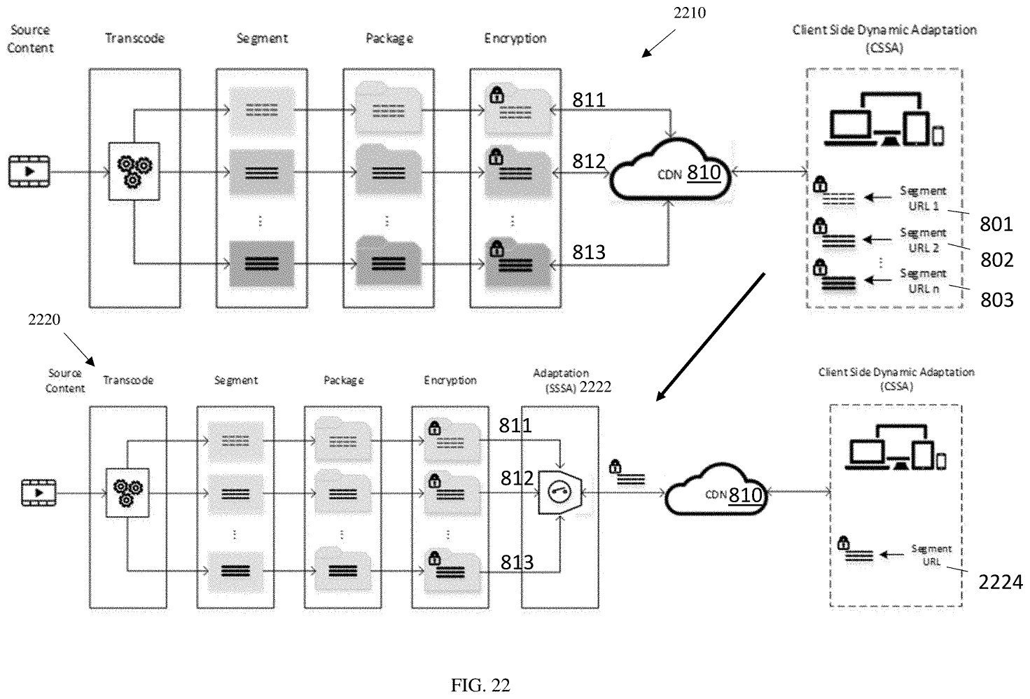

FIGS. 22-26 illustrates some aspects of some embodiments of the mixed-side dynamic adaptation (XSDA) or the present invention, including in comparison with CSDA and SSDA, according to some embodiments. FIG. 22 illustrates the movement of some processing from the client 2210 with Client Side Dynamic Adaptation (CSDA) to the server 2220 with Server Side Dynamic Adaptation (SSDA), according to some embodiments. For comparison purposes, as described in conjunction with FIG. 8, for the client side 2210, the client performs the adaptation logic that performs streaming adaptation in terms of selecting (e.g., encrypted) segments from a set of available streams 811, 812, and 813, for example, the segment URLs 801-803. As such, each of the encrypted segments 801, 802, and 803 are transmitted via the content delivery network (CDN) 810 and are all transmitted to the client device. The client device may then select the segments.

The techniques described herein can additionally or alternatively be used to provide SSDA 2220, where the adaptation 2222, including selecting from the available streams 811, 812 and 813 to determine the segment 2224, including rendering as may be requested by the client side, is performed prior to transmission of segments to the client via the CDN 810, such that the client can request that the server side perform some rendering, and, if the server side makes a determination to perform some or all of the requested rendering, the server side can perform such rendering prior to transmission to the client side.

The inventors have recognized that there are a number of complexities associated with a CSDA approach. For example, tile stitching on the fly in CSDA requires seamless stitching of tile segments with tile boundary padding to be performed at the client. Also, consistent quality management for retrieved and stitched tile segments should be addressed by the client in CSDA for stitching of tiles of different qualities. Tile buffering management including predicting user's movement should be done at the client in CSDA to avoid downloading of un-necessary tiles. With CSDA, viewport generation of 3D Point Cloud and immersive video constructing from compressed component video segments should be addressed at the client.

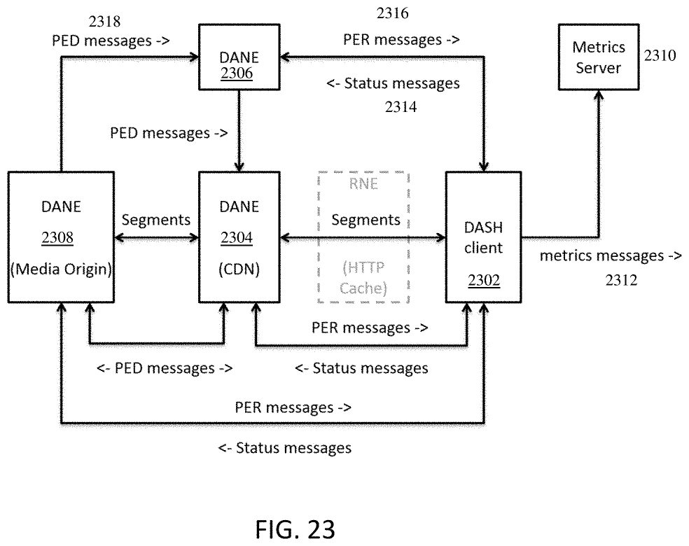

According to some embodiments, a SAND architecture can be used to provide new SAND messages in the form of HTTP header parameters between DASH clients and DANEs to support SSDA. FIG. 23 shows a mixed side dynamic adaptation (XSDA) architecture, wherein a portion of the dynamic adaptation is done at the client and a portion is done at the server, according to some embodiments. In some embodiments, messages and parameters are provided for exchange between clients and servers for supporting MPEG Dynamic Adaptive Streaming in HTTP (DASH) for the purpose of enabling SSDA (e.g., without requiring specification of normative server-side adaptation behaviors). The techniques described herein can be used for various types of data formats, such as regardless of whether SSDA is implemented using Derived Visual Tracks, through NBMP, etc. In some aspects, SAND architectures are leveraged to provide SAND messages in the form of HTTP parameters exchanged between DASH clients and Dash Aware Network Elements (DANEs), particularly CDNs, to support SSDA.

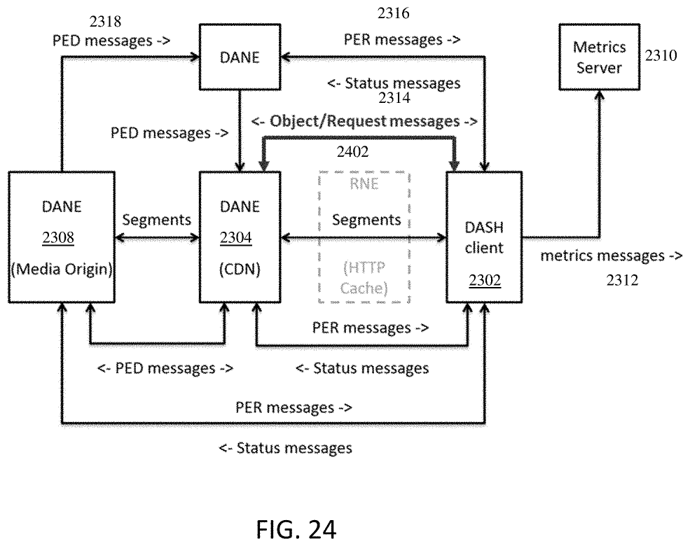

Referring also to FIG. 23, FIG. 24 shows how various types of messages can be exchanged among the DASH clients 2302, DANEs 2304, 2306, 2308, and a metric server 2310, according to some embodiments. The SAND specification, for example, includes four types of messages: metrics messages 2312 that are sent from DASH clients 2302 to Metrics Servers 2310, status messages 2314 that are sent from DASH clients 2302 to DANEs 2306, parameters Enhancing Reception (PER) messages that are sent from DANEs 2306 to DASH clients 2302, and Parameters Enhancing Delivery (PED) messages 2318 that are exchanged between DANEs 2304, 2306, 2308.

As an example, the CTA Common Media Client Data Client (CMDA) specification includes “keys” (or messages) that can be used by media player clients to convey information to Content Delivery Networks (CDNs) with each object request. Such keys or messages can be used, for example, for the purposes of log analysis, Quality of Service (QoS) monitoring and/or delivery optimization. See, for example, the CTA Specification, “Web Application Video Ecosystem—Common Media Client Data,” CTA-5004, the contents of which is herein incorporated by reference in its entirety. With respect to the SAND reference architecture, CMCD considers “messages” between DASH clients and CDNs, including the different types of messages relating to object requests, such as: request keys, whose values vary with each request; object keys, whose values vary with the object being requested; status keys, whose values do not vary with every request or object; and session keys, whose values are expected to be invariant over the life of the session.

In some embodiments, because SSDA is server-side dynamic adaptation for DASH clients, SSDA messages can have the same natures for CMCD-Requests and CMCD-Objects as the adaptation parameters updated in the DASH TuC (e.g., as discussed in MDS20870_WG03_N00393, “DASH TuC,” October 2021, the contents of which are herein incorporated by reference in their entirety).

FIG. 24 illustrates an enhancement to the SAND reference architecture with Request and Object messages 2402. The messages 2402 can be in the form of HTTP header parameters in HTTP requests and responses between DASH clients 2302 and DANEs 2304 in one aspect of the present invention.

Accordingly, the techniques provide for rendering adaptation, related to use cases wherein streaming clients and servers split rendering of, e.g., foreground and background content, possibly within a user's viewport. Various HTTP adaptation parameters can be used with the techniques described herein. For example, track selection or switching adaptation parameters can be used, such as discussed in conjunction with FIG. 12. As another example, spatial adaptation parameters for viewport and viewpoint selection can be used, such as the collection of viewport/viewpoint/spatial-object related data structure attributes from OMAF discussed in conjunction with FIGS. 13-14. As a further example, temporal adaptation parameters for join live and tune-in fast can be used, such as the collection of temporal adaptation related ones for use cases where the client needs to indicate to the server if a media request is for tuning into a live event (or channel) or joining fast into a stream as discussed in conjunction with FIG. 15.

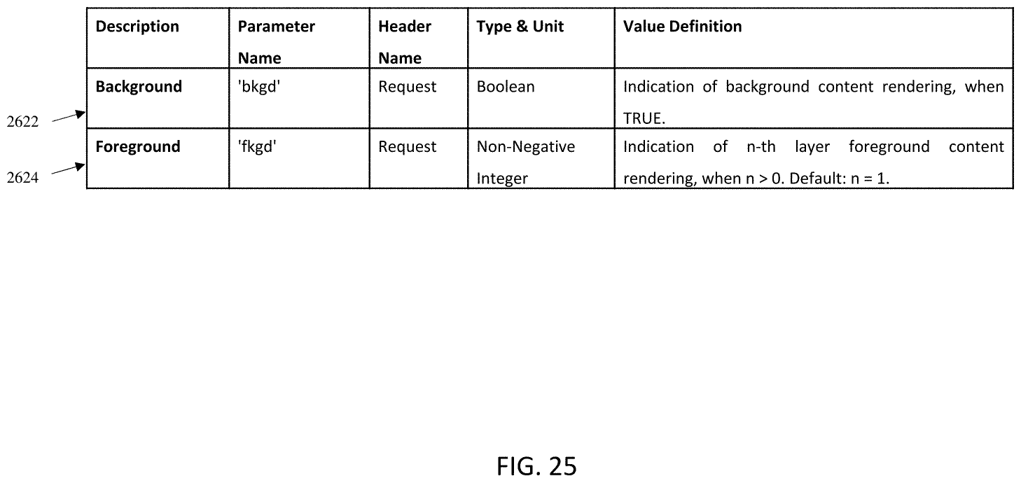

As an additional example, in some embodiments, additional rendering adaptations parameters are introduced for split rendering. FIG. 25 lists a collection of rendering adaptation related parameters for use cases wherein streaming clients and servers split rendering of foreground and background content, possibly within a user's viewport. When a background or foreground content is requested, the client may compose, or overlay received content with other content in the order of background 2622 and foreground 2624 layers. The background and foreground can be rendered independently, and thus either or both can be rendered by the server (and the server may also perform composition). In accordance with the techniques described herein, a client can ask the server to render background or foreground content using such parameters. In some embodiments, typical rendering is raster-based, such that the rendering device renders a scene in a raster format based on the information from the device (e.g., the viewport). For some scenarios, scenes can include a background and one or more other objects, such as a point cloud object. In such scenarios, a client can have the server help render the background object and send that in raster format so that the client can perform the composition.

In some embodiments, the rendering can be performed based on layers. For example, for multiple people in a queue, the nearest person may be on a highest layer while the farthest person is on lower layer. So depending on how the composition is performed, the nearest person can block part of the other person. As a result, rendering requests can be made based on associated layers of the content, such that the server side may process some layers while the client may process other layers and/or no layers (e.g., if all rendered by the server side).

Some aspects of the invention can relate to an alpha blending mode. For example, different layers (e.g., background/foreground, and/or other layers as discussed herein) can include an alpha blending mode to indicate how blending is performed for composition. Generally, the source can be the current layer and the destination can be the layer below. It should be appreciated that layers may have different sizes as well (e.g., where a destination layer covers the right ⅔ of a 2D scene and the source part covers the left ⅔, and thus the source and destination have ⅓ overlap). Accordingly, there can be different modes for blending when dealing with layers of content.

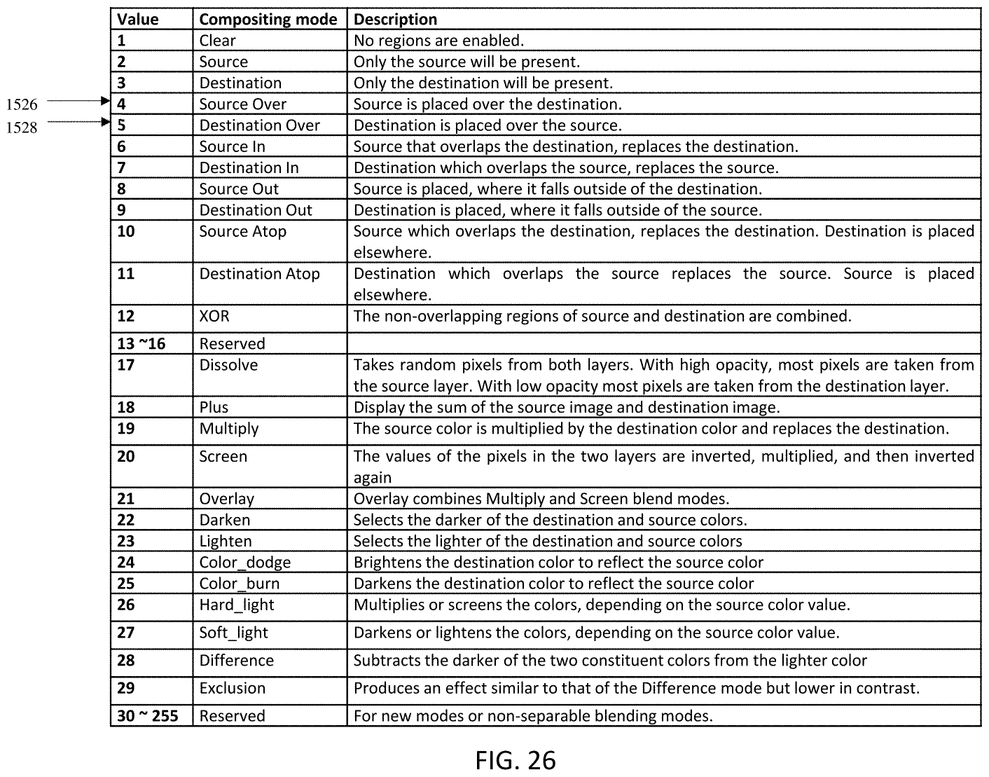

A table of valid values along with associated algorithms with default parameters may be specified in a separate document, e.g. ISO/IEC 23001-8 or “Composing and Blending Level 1.0”, W3C Candidate Recommendation, 13 Jan. 2015 (www.w3.org/TR/compositing-1/) (hereinafter, “ISO/IED 23001-8”), the contents of which are herein incorporated by reference. FIG. 26 is a listing of exemplary valid mode values for alpha_blending_mode. For example, a value of 4 representing compositing mode “Source Over” 1526 indicates that the source is placed over the destination. As another example, a value of 5 representing compositing mode “Destination over” 1528 indicates that the destination is placed over the source.

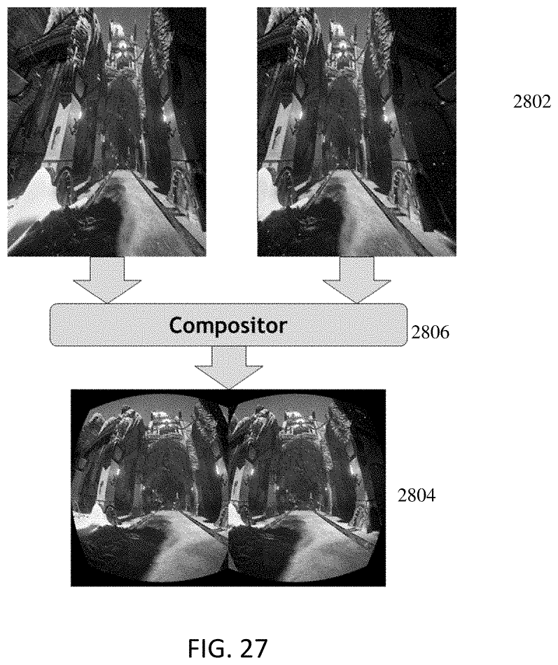

The split-rendering of the present invention differs from SSDA in several respects. Unlike split-rendering, the SSDA-based approach is still client driven, based on client requests. The SSDA-based is server assisted, meaning that the server fulfills client requests according to its best capabilities. While the SSDA-based can be dynamic (i.e., when and how often requests are made may vary in time), split rendering can also be dynamic, based on Client's static and dynamic capabilities. For example, a client's hardware/software capabilities are static and a client's network bandwidth, and resource availability (e.g., buffer level and power consumption) may be dynamic. FIG. 27 shows an example of a projection composition layer 2802 and the resulting composited distorted image 2804 for layer composition using a compositor 2806. Some embodiments of the present invention include a choice of a view configuration, depending on the target device and its capabilities, during setup of an OPEN XR session. In some embodiments both Mono and Stereo are natively supported by all XR runtimes. Some embodiments include advanced types such as the primary quad, which may be a vendor extension providing support for foveated rendering.

It should be appreciated that exemplary naming conventions, abbreviations, and the like have been used to provide examples of the techniques described herein. Such conventions are not intended to be limiting and instead are intended to simply provide examples. Accordingly, it should be appreciated that the techniques can be implemented using other conventions, abbreviations, and/or the like.

Techniques operating according to the principles described herein may be implemented in any suitable manner. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques—such as implementations where the techniques are implemented as computer-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

A computing device may comprise at least one processor, a network adapter, and computer-readable storage media. A computing device may be, for example, a desktop or laptop personal computer, a personal digital assistant (PDA), a smart mobile phone, a server, or any other suitable computing device. A network adapter may be any suitable hardware and/or software to enable the computing device to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media may be adapted to store data to be processed and/or instructions to be executed by processor. The processor enables processing of data and execution of instructions. The data and instructions may be stored on the computer-readable storage media.

A computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A method for providing video data for immersive media implemented by a server in communication with a client device, the method comprising:
receiving, from the client device, a request to access a stream of media data associated with immersive content, wherein the request comprises a rendering request for the server to render at least part of the stream of media data prior to transmission of the at least part of the stream of media data to the client;
determining, based on the rendering request, whether to render the at least part of the stream of media data for delivery to the client device; and
transmitting, in response to the request to access the stream of media data, a response to the client indicating the determination.

2. The method of claim 1, wherein the at least part of the stream of media data comprises a plurality of layers of media data.

3. The method of claim 2, wherein the plurality of layers of media data comprise a foreground layer, a background layer, or both.

4. The method of claim 3, wherein the rendering request comprises a request to render the foreground layer, the background layer, or both.

5. The method of claim 1, wherein the rendering request comprises a request to not render the at least part of the stream of media data.

6. The method of claim 1, wherein the rendering request comprises a request to render an additional part of the stream of media data.

7. The method of claim 1, wherein the rendering request comprises a request to compose rendered content.

8. The method of claim 1, wherein the determining, based on the rendering request, whether to render the at least part of the stream of media data comprises:
determining to render the at least part of the stream of media data;
rendering the at least part of the stream of media data to produce a rendered representation of the at least part of the stream of media data; and
transmitting the rendered representation of the at least part of the stream of media data to the client.

9. The method of claim 1, wherein the determining, based on the rendering request, whether to render the at least part of the stream of media data comprises:
determining not to render the at least part of the stream of media data.

10. The method of claim 1, further comprising:
receiving, from the client device, a first set of one or more parameters associated with a viewport of the client device;
rendering the at least part of the stream of media data in accordance with the first set of one or more parameters to produce a rendered representation of the at least part of the stream of media data; and
transmitting the rendered representation of the at least part of the stream of media data to the client.

11. The method of claim 10, wherein the first set of one or more parameters comprises one or more of an azimuth, an elevation, an azimuth range, an elevation range, a position, and a rotation.

12. The method of claim 11, wherein the position comprises three dimensional rectangular coordinates.

13. The method of claim 11, wherein the rotation comprises three rotational components in a three-dimensional rectangular coordinate system.

14. The method of claim 10, further comprising:
receiving, from the client device, a second set of one or more parameters associated with a spatial, planar object wherein said rendering the at least part of the stream of media data is done in accordance with both the first set of one or more parameters and the second set of one or more parameters.

15. The method of claim 14, wherein the second set of one or more parameters comprises one or more of a position of a portion of the object, a width of the object, and a height of the object.

16. The method of claim 15, wherein the position of the portion of the object comprises a horizontal position of a top left corner of the object and a vertical position of the top left corner of the object.

17. The method of claim 14, wherein the width of the object and/or the height of the object have arbitrary units.

18. A method for obtaining video data for immersive media implemented by a client device in communication with a server, the method comprising:
transmitting, to the server a request to access a stream of media data associated with immersive content, wherein the request comprises a rendering request for the server to render at least part of the stream of media data;
receiving a response indicating whether the server rendered the at least part of the stream of media data; and
receiving, if the response indicates that the server rendered the at least part of the stream of media data, a rendered representation of the at least part of the stream of media data.

19. The method of claim 18, wherein the rendering request comprises a request to render all of the stream of media data.

20. The method of claim 18, further comprising:
if the response indicates that the server did not render the at least part of the stream of media data, rendering a representation of the at least part of the stream of media data.

21. The method of claim 18, further comprising:
transmitting, to the server, a first set of one or more parameters associated with a viewport of the client device;
if the response indicates that the server rendered the at least part of the stream of media data, receiving, from the server, a rendered representation of the at least part of the stream of media data in accordance with the first set of one or more parameters.

22. The method of claim 21, further comprising:
transmitting, to the server, a second set of one or more parameters associated with a spatial, planar object; and
if the response indicates that the server rendered the at least part of the stream of media data, receiving, from the server, a rendered representation of the at least part of the stream of media data in accordance with the first set of one or more parameters and the second set of one or more parameters.

23. A system configured to provide video data for immersive media comprising a processor in communication with memory, the processor being configured to execute instructions stored in the memory that cause the processor to perform:
receiving a request to access a stream of media data associated with immersive content, wherein the request comprises a rendering request for the server to render at least part of the stream of media data prior to transmission of the at least part of the stream of media data;
determining, based on the rendering request, whether to render the at least part of the stream of media data; and
transmitting, in response to the request to access the stream of media data, a response indicating the determination.
